(19) United States
(12) Patent Application Publication
(10) Pub. No.: US 2014/0020779 A1
(43) Pub. Date: Jan. 23, 2014

(54) EXTREME FLOW RATE AND/OR HIGH TEMPERATURE FLUID DELIVERY SUBSTRATES

(71) Applicant: VISTADELTEK, LLC, Yorba Linda, CA (US)

(72) Inventor: Kim Ngoc Vu, Yorba Linda, CA (US)

(73) Assignee: VISTADELTEK, LLC, Yorba Linda, CA (US)

(21) Appl. No.: 14/037,854

(22) Filed: Sep. 26, 2013

Related U.S. Application Data
(63) Continuation-in-part of application No. 13/923,939, filed on Jun. 21, 2013.
Application No. 13/923,939 is a division of application No. 12/796,979, filed on Jun. 9, 2010, now Pat. No. 8,496,029.
(60) Provisional application No. 61/185,829, filed on Jun. 10, 2009.
(60) Provisional application No. 61/303,460, filed on Feb. 11, 2010.
(60) Provisional application No. 61/842,460, filed on Jul. 3, 2013.

(51) Int. Cl. F16L 41/02

(52) U.S. Cl. CPC F16L 41/02
USPC 137/884

(57) ABSTRACT

A flow substrate including a body having a first surface and a second opposing surface, a plurality of ports defined in a first surface of the body, a plurality of apertures defined in a second surface of the body, a plurality of fluid pathways, each fluid pathway of the plurality of fluid pathways including a first segment extending between a respective aperture of the plurality of apertures and a first port of a respective pair of ports and a second segment extending between the respective aperture and a second port of the respective pair of ports, and at least one cap. The at least one cap has a first surface constructed to seal at least one aperture of the plurality of apertures, and a second opposing surface.

### CROSS REFERENCE TO RELATED APPLICATIONS

This application claims the benefit of priority under 35 U.S.C. §119(e) to U.S. Provisional Application Ser. No. 61/842,460 titled “EXTREME FLOW RATE AND/OR HIGH TEMPERATURE FLUID DELIVERY SUBSTRATES,” filed on Jul. 3, 2013, and claims the benefit of priority under 35 U.S.C. §120 as a continuation-in-part of U.S. patent application Ser. No. 13/923,939 titled “EXTREME FLOW RATE AND/OR HIGH TEMPERATURE FLUID DELIVERY SUBSTRATES,” filed on Jun. 21, 2013. U.S. patent application Ser. No. 13/923,939 is a division under 35 U.S.C. §120 of U.S. patent application Ser. No. 12/796,979, titled “EXTREME FLOW RATE AND/OR HIGH TEMPERATURE FLUID DELIVERY SUBSTRATES,” filed on Jun. 9, 2010, (now U.S. Pat. No. 8,496,029), which claims the benefit of priority under 35 U.S.C. §119(e) to U.S. Provisional Patent Application Ser. No. 61/185,829, titled “HIGH FLOW RATE AND/OR HIGH TEMPERATURE FLUID DELIVERY SUBSTRATES,” filed on Jun. 10, 2009, and to U.S. Provisional Patent Application Ser. No. 61/303,460, titled “EXTREME FLOW RATE AND/OR HIGH TEMPERATURE FLUID DELIVERY SUBSTRATES,” filed on Feb. 11, 2010. This application is related to U.S. patent application Ser. No. 12/777,327, titled “FLUID DELIVERY SUBSTRATES FOR BUILDING REMOVABLE STANDARD FLUID DELIVERY STICKS, filed May 11, 2010 (now U.S. Pat. No. 8,307,854). The contents of the aforementioned applications are hereby incorporated by reference in their entirety.

### BACKGROUND OF THE INVENTION

1. Field of the Invention

The present invention is directed to fluid delivery systems, and more particularly to extreme flow rate and/or high temperature surface mount fluid delivery systems for use in the semiconductor processing and petrochemical industries.

2. Discussion of the Related Art

Fluid delivery systems are used in many modern industrial processes for conditioning and manipulating fluid flows to provide controlled admittance of desired substances into the processes. Practitioners have developed an entire class of fluid delivery systems which have fluid handling components removably attached to flow substrates containing fluid pathway conduits. The arrangement of such flow substrates establishes the flow sequence by which the fluid handling components provide the desired fluid conditioning and control. The interface between such flow substrates and removable fluid handling components is standardized and of few variations. Such fluid delivery system designs are often described as modular or surface mount systems. Representative applications of surface mount fluid delivery systems include gas panels used in semiconductor manufacturing equipment and sampling systems used in petrochemical refining. The many types of manufacturing equipment used to perform process steps making semiconductors are collectively referred to as tools. Embodiments of the present invention relate generally to fluid delivery systems for semiconductor processing and specifically to surface mount fluid delivery systems that are specifically well suited for use in extreme flow rate and/or high temperature applications where the process fluid is to be heated to a temperature above ambient. Aspects of the present invention are applicable to surface mount fluid delivery system designs whether of a localized nature or distributed around a semiconductor processing tool.

Industrial process fluid delivery systems have fluid pathway conduits fabricated from a material chosen according to its mechanical properties and considerations of potential chemical interaction with the fluid being delivered. Stainless steels are commonly chosen for corrosion resistance and robustness, but aluminum or brass may be suitable in some situations where cost and ease of fabrication are of greater concern. Fluid pathways may also be constructed from polymer materials in applications where possible ionic contamination of the fluid would preclude using metals. The method of sealingly joining the fluid handling components to the flow substrate fluid pathway conduits is usually standardized within a particular surface mount system design in order to minimize the number of distinct part types. Most joining methods use a deformable gasket interposed between the fluid component and the flow substrate to which it is attached. Gaskets may be simple elastomeric O-Rings or specialized metal sealing rings such as seen in U.S. Pat. No. 5,803,507 and U.S. Pat. No. 6,357,760. Providing controlled delivery of high purity fluids in semiconductor manufacturing equipment has been of concern since the beginning of the semiconductor electronics industry and the construction of fluid delivery systems using mostly metallic seals was an early development. One early example of a suitable bellows sealed valve is seen in U.S. Pat. No. 3,278,156, while the widely used VCR® fitting for joining fluid conduits is seen in U.S. Pat. No. 3,521,910, and a typical early diaphragm sealed valve is seen in U.S. Pat. No. 5,730,423 for example. The recent commercial interest in photovoltaic solar cell fabrication, which has less stringent purity requirements than needed for making the newest microprocessor devices, may bring a return to fluid delivery systems using elastomeric seals.

A collection of fluid handling components assembled into a sequence intended for handling a single fluid species is frequently referred to as a gas stick. The equipment subsystem comprised of several gas sticks intended to deliver process fluid to a particular semiconductor processing chamber is often called a gas panel. During the 1990s several inventors attacked problems of gas panel maintainability and size by creating gas sticks wherein the general fluid flow path is comprised of passive metallic structures, containing the conduits through which process fluid moves, with valves and like active (and passive) fluid handling components removably attached thereto. The passive fluid flow path elements have been variously called manifolds, substrates, blocks, and the like, with some inconsistency even within the work of individual inventors. This disclosure chooses to use the terminology flow substrate to indicate fluid delivery system elements which contain passive fluid flow path(s) that may have other fluid handling devices mounted there upon.

### SUMMARY OF THE INVENTION

Embodiments of the present invention are directed to a surface mount fluid delivery flow substrate that is specifically adapted for use in extreme flow rate and/or high temperature applications where the process fluid is to be heated (or cooled) to a temperature above (or below) that of the ambient environment. As used herein, and in the context of semiconductor process fluid delivery systems, the expression “extreme flow rate” corresponds to gas flow rates above approximately 50 SLM or below approximately 50 SCCM. A significant aspect of the present invention is the ability to fabricate flow substrates having fluid pathway conduits with a cross-sectional area (size) substantially larger or smaller than other surface mount architectures.

Flow substrates in accordance with the present invention may be used to form a portion of a gas stick, or may be used to form an entire gas stick. Certain embodiments of the present invention may be used to implement an entire gas panel using only a single flow substrate. Flow substrates of the present invention may be securely fastened to a standardized stick bracket, such as that described in Applicant's patent application Ser. No. 12/777,327, filed on May 11, 2010 (now U.S. Pat. No. 8,307,854; hereinafter, “Applicant's '854 application”), thereby providing firm mechanical alignment and thereby obviating need for any interlocking flange structures among the flow substrates. In addition, flow substrates of the present invention may be adapted as described in Applicant's '854 application to additionally provide one or more manifold connection ports and thereby allow transverse connections between fluid delivery sticks.

The flow substrate configurations of the present invention may be adjusted for use with valves and other fluid handling components having symmetric port placement (e.g., W-seal™ devices) or asymmetric port placement (e.g., standard “C-Seal” devices) on the valve (or other fluid handling component) mounting face. Only asymmetric designs are shown herein because such devices are most commonly available in the semiconductor equipment marketplace.

In accordance with one aspect of the present invention, a flow substrate is provided. The flow substrate comprises a substrate body formed from a solid block of a first material, the substrate body having a first surface and a second surface opposing the first surface; a plurality of pairs of component conduit ports defined in the first surface of the substrate body; a plurality of fluid pathways extending between each respective pair of component conduit ports and in fluid communication with each component conduit port of the respective pair of component conduit ports, each respective fluid pathway being formed in the second surface of the substrate body; and at least one cap. The at least one cap is formed from a second material and has a first surface that is constructed to seal at least one fluid pathway of the plurality of fluid pathways, and a second surface opposing the first surface of the at least one cap. At least one of the substrate body and the at least one cap includes a weld formation (also commonly referred to as a “weld preparation”) formed in at least one of the second surface of the substrate body and the second surface of the at least one cap, wherein the weld formation is constructed to surround the at least one fluid pathway and facilitate welding of the at least one cap to the substrate body along the weld formation. As used herein, the term “weld formation” (or alternatively “weld preparation”) refers to a structure formed in one or more pieces of material that are to be welded together that aids in the formation of the welded joint. Weld formations may vary dependent on the types of materials to be welded together, their thicknesses, and the type of welded joint to be formed (e.g., a butt joint, a lap joint, a tee joint, a corner joint, and edge joint, etc.) as known to those skilled in the art.

In accordance with one embodiment, the component conduit ports extend through the substrate body to the second surface of the substrate body, and the first material and the second material are stainless steel of the same alloy type. In another embodiment, the first material may be a stainless steel, and the second material may be a nickel alloy, such as a Hastelloy® corrosion resistant metal alloy, available from Haynes International, Inc.

In accordance with another embodiment, the substrate body includes a first weld formation formed in the second surface of the substrate body and the at least one cap includes a second weld formation formed in the second surface of the at least one cap.

In accordance with yet another embodiment, the at least one cap includes the weld formation, wherein the weld formation includes a groove formed in the second surface of the at least one cap. In accordance with one aspect of this embodiment, the groove facilitates welding of the at least one cap to the substrate body by identifying the location of where the at least one cap is to be welded to the substrate body and by reducing the power needed to weld the at least one cap to the substrate body. In accordance with another aspect of this embodiment, the groove may be formed in the second surface of the at least one cap by chemical etching. In a further aspect of this embodiment, the at least one cap has a thickness of approximately 0.5 mm, and the groove has a depth of approximately 0.25 mm. In accordance with a further aspect of this embodiment, the flow substrate may further comprise a plate formed from a rigid material and constructed to be disposed adjacent the second surface of the at least one cap, and may additionally comprise a sheet heater, wherein the sheet heater is constructed to be disposed between the plate and the second surface of the at least one cap.

In accordance with another embodiment, the at least one cap includes a plurality of weld formations, each weld formation of the plurality of weld formations including a respective groove formed in the second surface of the at least one cap, each respective groove of the plurality of grooves surrounding a respective one of the plurality of fluid pathways.

In accordance with yet another embodiment, the at least one cap includes a plurality of caps corresponding to each of the plurality of fluid pathways, each respective cap of the plurality of caps including a respective groove formed in the second surface of the respective cap.

In accordance with another embodiment, the substrate body includes the weld formation formed in the second surface of the substrate body, the weld formation including a recessed weld wall surface surrounding the at least one fluid pathway. In accordance with one aspect of this embodiment, the weld formation further includes a stress relief groove surrounding the recessed weld wall surface. In accordance with another aspect of this embodiment, the weld formation further includes a swaged lip surrounding the at least one fluid pathway and disposed between the at least one fluid pathway and the recessed weld wall surface, and in a further aspect of this embodiment, the weld formation further includes a stress relief groove surrounding the recessed weld wall surface.

In accordance with another embodiment, the flow substrate forms a portion of a gas stick for conveying one of semiconductor process fluids and sampling fluids and petrochemical fluids, and in another embodiment, the flow substrate forms substantially all of a fluid delivery panel.

In accordance with another aspect of the invention, a flow substrate is provided. The fluid flow substrate comprises a substrate body formed from a solid block of a first material, the substrate body having a first surface and a second surface opposing the first surface; a plurality of pairs of component conduit ports defined in the first surface of the substrate body; a plurality of fluid pathways extending between each respective pair of component conduit ports and in fluid communication with each component conduit port of the respective pair of component conduit ports, each respective fluid pathway being formed in the second surface of the substrate body; a plurality of seals corresponding to each of the plurality of fluid pathways; and at least one cap. The at least one cap is formed from a second material, the at least one cap having a first surface that is constructed to seal at least one fluid pathway of the plurality of fluid pathways, and a second surface opposing the first surface of the at least one cap. The at least one cap is configured to receive and retain at least one seal of the plurality of seals in registration with the at least one cap and to form a fluid tight seal with the at least one fluid pathway upon compression against the substrate body.

In accordance with one embodiment, the component conduit ports extend through the substrate body to the second surface of the substrate body.

In accordance with one embodiment, the first material and the second material are plastic, and in accordance with another embodiment, the first material is plastic, and the second material is metal.

In accordance with one embodiment, the at least one cap includes a groove formed in the first surface of the at least one cap and dimensioned to retain the at least one seal. In accordance with a further aspect of this embodiment, the groove is formed in the first surface of the at least one cap by one of molding and machining.

In accordance with another embodiment, the at least one cap includes a plurality of grooves formed in the first surface of the at least one cap, each respective groove of the plurality of grooves being dimensioned to retain a respective seal of the plurality of seals.

In accordance with yet another embodiment, the at least one cap includes a plurality of caps corresponding to each of the plurality of fluid pathways, each respective cap of the plurality of caps being configured to receive and retain a respective seal of the plurality of seals between the first and second surfaces of the respective cap. In accordance with a further aspect of this embodiment, the first and second surfaces of each respective cap are separated by an intermediate portion of the respective cap, the intermediate portion having a smaller cross-sectional extent than either of the first and second surfaces of the respective cap, and in a further aspect of this embodiment, the first and second surfaces of each respective cap are dimensioned to be the same.

In accordance with another embodiment, the flow substrate may further comprise a plate formed from a rigid material and constructed to be disposed adjacent the second surface of the at least one cap and to compress the at least one cap against the substrate body.

In accordance with another aspect of the present invention, a flow substrate is provided comprising a substrate body formed from a solid block of a first material, the substrate body having a first surface and a second surface opposing the first surface; a plurality of pairs of component conduit ports defined in the first surface of the substrate body; a plurality of fluid pathways extending between each respective pair of component conduit ports and in fluid communication with each conduit port of the respective pair of component conduit ports, each respective fluid pathway being formed in the second surface of the substrate body; and a cap. The cap is formed from a second material and has a first surface to be placed in registration with the second surface of the substrate body, and a second surface opposing the first surface of the cap. The second surface of the cap has a plurality of weld formations formed therein, each respective weld formation of the plurality of weld formations being constructed to surround a respective fluid pathway of the plurality of fluid pathways and define a location where the cap is to be welded to the second surface of the substrate body.

In accordance with one embodiment, the first material and the second material are stainless steel of the same alloy type, the cap has a thickness of approximately 0.5 mm, and each of the plurality of weld formations includes a groove having a depth of approximately 0.25 mm.

In accordance with a further embodiment, the flow substrate may further comprise a plate formed from a rigid material and constructed to be disposed adjacent the second surface of the cap, and a sheet heater constructed to be disposed between the plate and the second surface of the cap.

In accordance with an aspect of the present invention, the flow substrate may form at least a portion a gas stick for conveying one of semiconductor process fluids and sampling fluids and petrochemical fluids.

In accordance with another aspect of the present invention, a flow substrate is provided comprising a substrate body formed from a solid block of a first material, the substrate body having a first surface and a second surface opposing the first surface; a plurality of pairs of component conduit ports defined in the first surface of the substrate body; a plurality of fluid pathways extending between each respective pair of component conduit ports and in fluid communication with each conduit port of the respective pair of component conduit ports, each respective fluid pathway being formed in the second surface of the substrate body; and a plurality of caps. Each of the plurality of caps are formed from a second material, each respective cap of the plurality of caps having a first surface to seal a respective fluid pathway of the plurality of fluid pathways and a second surface opposing the first surface of the respective cap. Each respective cap of the plurality of caps including a weld formation, formed in the second surface of the respective cap, and constructed to surround a respective fluid pathway of the plurality of fluid pathways and facilitate welding of the respective cap to the substrate body along the weld formation.

In accordance with one aspect of this embodiment, the substrate body may include a plurality of weld formations formed in the second surface of the substrate body and surrounding a respective one of the plurality of fluid pathways.

In accordance with yet another aspect of the present invention, a flow substrate is provided. The flow substrate comprises a substrate body formed from a solid block of a first material, the substrate body having a first surface and a second surface opposing the first surface; a plurality of pairs of component conduit ports defined in the first surface of the substrate body; a plurality of fluid pathways extending between each respective pair of component conduit ports and in fluid communication with each conduit port of the respective pair of component conduit ports, each respective fluid pathway being formed in the second surface of the substrate body; a plurality of weld formations, formed in the second surface of the substrate body, each respective weld formation of the plurality of weld formations surrounding a respective fluid pathway of the plurality of fluid pathways; and a plurality of caps. Each of the plurality of caps may be formed from a second material, and each respective cap of the plurality of caps is constructed to be welded to the substrate body along a respective weld formation of the plurality of weld formations.

In accordance with one embodiment, each respective weld formation includes a swaged lip surrounding a respective fluid pathway.

In accordance with another embodiment, each respective cap of the plurality of caps includes a first surface constructed to seal a respective fluid pathway of the plurality of fluid pathways and a second surface opposing the first surface, wherein each respective cap includes a weld formation formed in the second surface of the respective cap to facilitate welding of the respective cap to the substrate body.

In accordance with yet another aspect of the present invention, a flow substrate is provided comprising a substrate body formed from a solid block of a first material, the substrate body having a first surface and a second surface opposing the first surface; a plurality of pairs of component conduit ports defined in the first surface of the substrate body; a plurality of fluid pathways extending between each respective pair of component conduit ports and in fluid communication with each conduit port of the respective pair of component conduit ports, each respective fluid pathway being formed in the second surface of the substrate body; a plurality of seals corresponding to each of the plurality of fluid pathways; and a cap. The cap is formed from a second material and configured to be attached to the second surface of the substrate body. The cap has a first surface that to be disposed in registration with the second surface of the substrate body, and a second surface opposing the first surface of the cap, the cap including a plurality of grooves defined therein. Each respective groove of the plurality of grooves is constructed to surround a respective fluid pathway of the plurality of fluid pathways and to receive a respective seal of the plurality of seals.

In accordance with one aspect of this embodiment, each respective groove of the plurality of grooves is dimensioned to receive and retain a respective seal of the plurality of seals within the respective groove prior to attachment of the cap to second surface of the substrate body.

In accordance with another aspect of the present invention, a flow substrate is provided. The flow substrate comprises a substrate body formed from a solid block of a first material, the substrate body having a first surface and a second surface opposing the first surface; a plurality of pairs of component conduit ports defined in the first surface of the substrate body; a plurality of fluid pathways extending between each respective pair of component conduit ports and in fluid communication with each conduit port of the respective pair of component conduit ports, each respective fluid pathway being formed in the second surface of the substrate body; a plurality of seals corresponding to each of the plurality of fluid pathways; and a plurality of caps formed from a second material and corresponding to each of the plurality of fluid pathways. Each respective cap of the plurality of caps is constructed to receive and retain a respective seal of the plurality of seals and to form a fluid tight seal with a respective fluid pathway of the plurality of fluid pathways upon compression of the respective cap against the substrate body.

In accordance with an aspect of this embodiment, the flow substrate may further comprise a plate formed from a rigid material and constructed to be disposed in registration with the second surface of the substrate body and to compress each of the plurality of caps against the substrate body.

In accordance with an aspect of each of the above described embodiments, a first fluid pathway of the plurality of fluid pathways may have a different cross-sectional area than a second fluid pathway of the plurality of fluid pathways. In addition, in accordance with each of the above-described embodiments, the plurality of fluid pathways may be a first plurality of fluid pathways that extend between each respective pair of component conduit ports in a first direction, and wherein the flow substrate further includes at least one second fluid pathway formed in one of the first surface and the second surface of the substrate body that extends in a second direction that is transverse to the first direction.

In accordance with yet another aspect of the disclosure, a flow substrate is provided comprising a substrate body formed from a solid block of a first material, the substrate body having a first surface and a second surface opposing the first surface; a plurality of component conduit ports defined in the first surface of the substrate body; a plurality of apertures defined in the second surface of the substrate body; a plurality of fluid pathways, each fluid pathway of the plurality of fluid pathways including a first segment extending between a respective aperture of the plurality of apertures and a first component conduit port of a respective pair of component conduit ports and a second segment extending between the respective aperture and a second component conduit port of the respective pair of component conduit ports; and at least one cap formed from a second material, the at least one cap having a first surface that is constructed to seal at least one aperture of the plurality of apertures, and a second surface opposing the first surface of the at least one cap. At least one of the substrate body and the at least one cap includes a weld formation formed in at least one of the second surface of the substrate body and the second surface of the at least one cap, wherein the weld formation is constructed to surround the at least one aperture and facilitate welding of the at least one cap to the substrate body along the weld formation.

In accordance with at least one embodiment, the first segment and the second segment each extend at an angle relative to the second surface. In accordance with another aspect of this embodiment, the first segment and the second segment each extend at an angle between 35° and 50° relative to the second surface. In accordance with a further aspect, the first segment extends at a different angle than the second segment. In accordance with another aspect, a first segment and a second segment of a first fluid pathway extends at a different angle than a first segment and a second segment of a second fluid pathway.

In accordance with one embodiment, the first segment has a different cross-sectional area than the second segment.

In accordance with at least one aspect, the respective aperture of the plurality of apertures is formed equidistant between the first component conduit port and the second component conduit port of the respective pair of component conduit ports. In another aspect, the respective aperture of the plurality of apertures is formed asymmetrically between the first component conduit port and the second component conduit port of the respective pair of component conduit ports.

In accordance with various embodiments, the flow substrate further comprises at least one third component conduit port formed in the first surface of the substrate body and at least one fluid pathway extending parallel to the first surface and in fluid communication with the at least one third component conduit port.

In accordance with yet another embodiment, the plurality of fluid pathways extend in a first direction, and the flow substrate further comprises at least one fluid pathway extending in a second direction that is transverse to the first direction. In a further aspect, the at least one fluid pathway extending in the second direction includes at least one segment having a different cross-sectional area than a cross-sectional area of at least one of the first segment and the second segment. According to another aspect, the plurality of fluid pathways that extend in the first direction includes a first plurality of fluid pathways extending in the first direction along a first axis and a second plurality of fluid pathways extending in the first direction along a second axis, the first axis being substantially parallel with the second axis, and the at least one fluid pathway extends in the second direction between the first plurality of fluid pathways and the second plurality of fluid pathways. In a further aspect, the flow substrate further comprises at least one aperture associated with the at least one fluid pathway and positioned between the first plurality of fluid pathways and the second plurality of fluid pathways.

In accordance with certain embodiments, the plurality of component conduit ports are a first plurality of pairs of component conduit ports, the plurality of fluid pathways are a first plurality of fluid pathways that extend in a first direction, and the flow substrate further comprises at least one third component conduit port formed in at least one of the first surface and the second surface of the substrate body and at least one fluid pathway extending in a second direction that is transverse to the first direction and in fluid communication with the at least one third component conduit port. In a further embodiment, the at least one fluid pathway extending in the second direction includes at least one segment having a different cross-sectional area than a cross-sectional area of at least one of the first segment and the second segment.

In accordance with one or more embodiments, at least one aperture of the plurality of apertures has a circular cross-sectional area.

In accordance with other embodiments, the first component conduit port and the second component conduit port of the respective pair of component conduit ports is formed by machining from the first surface into the substrate body, each aperture of the respective plurality of apertures is formed by machining from the second surface into the substrate body, and each fluid pathway of the plurality of fluid pathways is formed by machining from the aperture to at least one of the first component conduit port and the second component conduit port.

In accordance with at least one embodiment, the flow substrate further comprises a third component conduit port extending from the first surface of the substrate body and through the substrate body to the second surface of the substrate body, the third component conduit port being configured to receive a fluid handling component that fluidly couples the third component conduit port with a first component conduit port of a respective first pair of component conduit ports and a second component conduit port of a respective second pair of component conduit ports.

In accordance with at least one embodiment, the at least one cap is constructed to seal at least two of the plurality of apertures.

In accordance with some embodiments the flow substrate forms substantially all of a fluid delivery panel.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a plan view of a first embodiment of a flow substrate in accordance with the present invention;

FIG. 1B is a cross-sectional view of the flow substrate of FIG. 1A taken along line A-A in FIG. 1A;

FIG. 1C illustrates a view of the flow substrate of FIGS. 1A and 1B from below;

FIG. 1D is an elevational view of the flow substrate of FIGS. 1A-C;

FIG. 1E is a cross-sectional view of the flow substrate of FIG. 1B taken along line B-B in FIG. 1B;

FIG. 1F is a cross-sectional view of the flow substrate of FIG. 1B taken along line C-C in FIG. 1B;

FIG. 1G is an end view of the flow substrate of FIGS. 1A-F;

FIG. 1H is an exploded view of a portion of the flow substrate depicted in FIG. 1B;

FIG. 1I is an elevational view of the flow substrate of FIGS. 1A-H from below;

FIG. 1J is a cut-away elevational view of the flow substrate of FIGS. 1A-I;

FIG. 2A is a plan view of a second embodiment of a flow substrate in accordance with the present invention;

FIG. 2B is a cross-sectional view of the flow substrate of FIG. 2A taken along line A-A in FIG. 2A;

FIG. 2C illustrates a view of the flow substrate of FIGS. 2A and 2B from below;

FIG. 2D is an elevational view of the flow substrate of FIGS. 2A-C;

FIG. 2E is a cross-sectional view of the flow substrate of FIG. 2B taken along line B-B in FIG. 2B;

FIG. 2F is an exploded view of a portion of the flow substrate depicted in FIG. 2B;

FIG. 2G illustrates various elevational views of the flow substrate of FIGS. 2A-F from below prior to assembly of the cap;

FIG. 2H illustrates an elevational view of the flow substrate of FIGS. 2A-G from below after assembly of the cap;

FIG. 3A is a plan view of a third embodiment of a flow substrate in accordance with the present invention;

FIG. 3B is a cross-sectional view of the flow substrate of FIG. 3A taken along line A-A in FIG. 3A;

FIG. 3C illustrates a view of the flow substrate of FIGS. 3A and 3B from below;

FIG. 3D is an exploded cross-sectional view of a portion of the flow substrate of FIGS. 3A-C taken along line B-B in FIG. 3B;

FIG. 3E is an exploded elevational view of a portion of the flow substrate of FIGS. 3A-D from below showing a first weld preparation;

FIG. 4A is a plan view of fourth embodiment of a flow substrate in accordance with the present invention;

FIG. 4B is a cross-sectional view of the flow substrate of FIG. 4A taken along line A-A in FIG. 4A;

FIG. 4C is an exploded cross-sectional view of a portion of the flow substrate of FIGS. 4A-B taken along line B-B in FIG. 4B;

FIG. 4D is an exploded elevational view of a portion of the flow substrate of FIGS. 4A-C from below showing a second weld preparation;

FIG. 4E is a cross-sectional view of a flow substrate of FIGS. 4A-D in which the weld cap is shown in position;

FIG. 4F is an exploded cross-sectional view of a portion of the flow substrate of FIG. 4E;

FIG. 4G is an elevational view of the flow substrate of FIGS. 4A-F from below;

FIG. 5 illustrates various views of a weld cap for use with the flow substrates of FIGS. 3-4 in accordance with an aspect of the present invention;

FIG. 6A is a cross-sectional view of a flow substrate in accordance with the fourth embodiment of the present invention that includes a third weld preparation;

FIG. 6B is an exploded cross-sectional view of a portion of the flow substrate of FIG. 6A taken along line B-B in FIG. 6A;

FIG. 6C is an exploded elevational view of a portion of the flow substrate of FIGS. 6A-B from below showing the third weld preparation;

FIG. 6D is a cross-sectional view of the flow substrate of FIGS. 6A-C in which the weld cap is shown in position;

FIG. 6E is an exploded cross-sectional view of a portion of the flow substrate and cap of FIG. 6D;

FIG. 7A is a cross-sectional view of a flow substrate in accordance with the fourth embodiment of the present invention that includes a fourth weld preparation;

FIG. 7B is an exploded cross-sectional view of a portion of the flow substrate of FIG. 7A taken along line B-B in FIG. 7A;

FIG. 7C is an exploded elevational view of a portion of the flow substrate of FIGS. 7A-B from below showing the fourth weld preparation;

FIG. 7D is a cross-sectional view of the flow substrate of FIGS. 7A-C in which the weld cap is shown in position;

FIG. 7E is an exploded cross-sectional view of a portion of the flow substrate and cap of FIG. 7D;

FIG. 8A is a cross-sectional view of a flow substrate in accordance with the fourth embodiment of the present invention that includes a fifth weld preparation;

FIG. 8B is an exploded cross-sectional view of a portion of the flow substrate of FIG. 8A taken along line B-B in FIG. 8A;

FIG. 8C is an exploded elevational view of a portion of the flow substrate of FIGS. 8A-B from below showing the fifth weld preparation;

FIG. 8D is a cross-sectional view of the flow substrate of FIGS. 8A-C in which the weld cap is shown in position;

FIG. 8E is an exploded cross-sectional view of a portion of the flow substrate and cap of FIG. 8D;

FIGS. 9A-B illustrate various views of a weld cap for use with the flow substrates of FIGS. 7-8 in accordance with an aspect of the present invention;

FIG. 10A is a cross-sectional view of a flow substrate in accordance with the fourth embodiment of the present invention that includes a cap and an elastomeric seal;

FIG. 10B is an exploded cross-sectional view of a portion of the flow substrate of FIG. 10A taken along line B-B in FIG. 10A;

FIG. 10C is an exploded elevational view of a portion of the flow substrate of FIGS. 10A-B from below;

FIG. 10D is a cross-sectional view of the flow substrate of FIGS. 10A-C in which the cap and elastomeric seal are shown in position with a backup plate;

FIG. 10E is an exploded cross-sectional view of a portion of the flow substrate and cap of FIG. 10D;

FIG. 10F illustrates an elevational view of the flow substrate, cap, elastomeric seal, and backup plate of FIGS. 10A-E prior to assembly;

FIG. 10G illustrates an elevational view of the flow substrate, cap, elastomeric seal, and backup plate of FIGS. 10A-F after assembly of the cap and elastomeric seal;

FIG. 11A illustrates the manner in which a single fluid substrate may be used to implement all or a portion of a heated gas panel in accordance with one embodiment of the present invention;

FIG. 11B illustrates the manner in which a single fluid substrate may be used to implement all or a portion of a heated gas panel in accordance with another embodiment of the present invention;

FIG. 12A illustrates a fluid flow panel for use with liquids and gases in which the entire fluid panel is implemented with two fluid flow substrates in accordance with an embodiment of the present invention;

FIG. 12B illustrates an elevational view of the fluid flow panel of FIG. 12A;

FIG. 12C illustrates a portion of the fluid flow panel of FIGS. 12A-B in which fluid pathways formed within the fluid flow substrate are visible.

FIG. 13A is a top plan view of a flow substrate in accordance with aspects of the invention;

FIG. 13B is a cross-sectional view of the flow substrate of FIG. 13A taken along line B-B in FIG. 13A;

FIG. 13C is a fluid flow diagram of the cross-sectional view illustrated in FIG. 13B;

FIG. 13D illustrates a view of the flow substrate of FIGS. 13A-13C from below;

FIG. 13E is an end view of the flow substrate of FIGS. 13A-13D;

FIG. 13F is an elevational view of the flow substrate of FIGS. 13A-E from above;

FIG. 13G is a cut-away elevational view of the flow substrate of FIGS. 13A-13F from above;

FIG. 13H is a cut-away elevational view of the flow substrate of FIGS. 13A-13G from below;

FIG. 14A is a bottom plan view of a flow substrate in accordance with aspects of the invention;

FIG. 14B is a cross-sectional view of the flow substrate of FIG. 14A taken along line B-B in FIG. 14A;

FIG. 14C is a top plan view of the flow substrate illustrated in FIGS. 14A and 14B;

FIG. 14D is an elevational view of the flow substrate of FIGS. 14A-14C from above;

FIG. 14E is an elevational view of the flow substrate of FIGS. 14A-14D from below;

FIG. 14F is a cut-away elevational view of the flow substrate of FIGS. 14A-14E from above;

FIG. 14G is a cut-away elevational view of the flow substrate of FIGS. 14A-14F from below; and

FIG. 15 is an elevational view of a flow substrate in accordance with aspects of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

It should be appreciated that the fluid materials manipulated in the fluid delivery flow substrates of the present invention may be a gaseous, liquid, or vaporous substance that may change between liquid and gas phase dependent upon the specific temperature and pressure of the substance. Representative fluid substances may be a pure element such as argon (Ar), a vaporous compound such as boron trichloride (BCl3), a mixture of normally liquid silicon tetrachloride (SiCl4) in carrier gas, or an aqueous reagent.

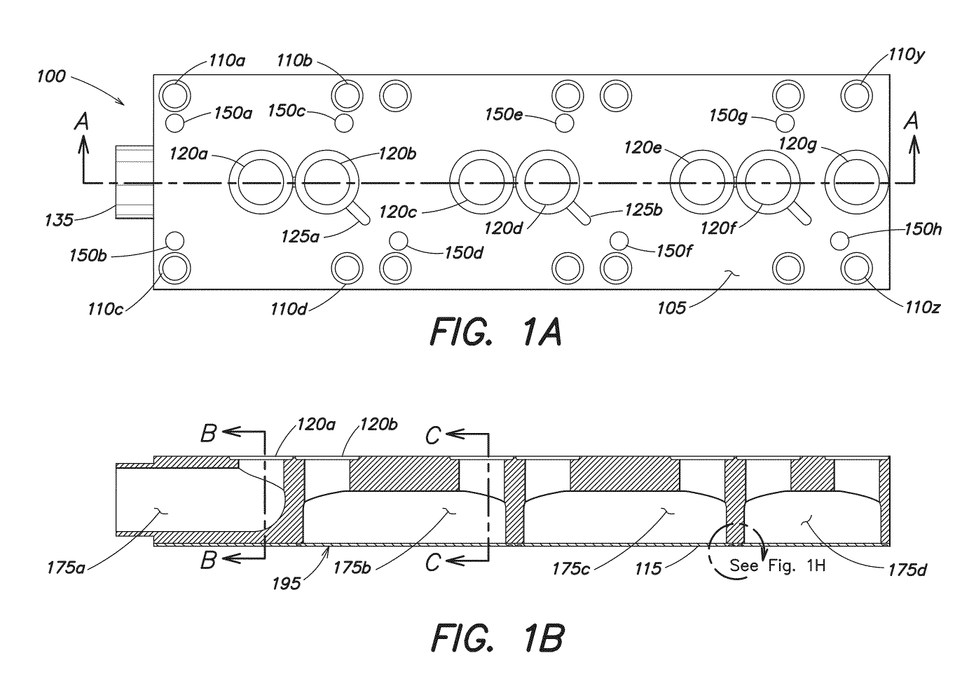

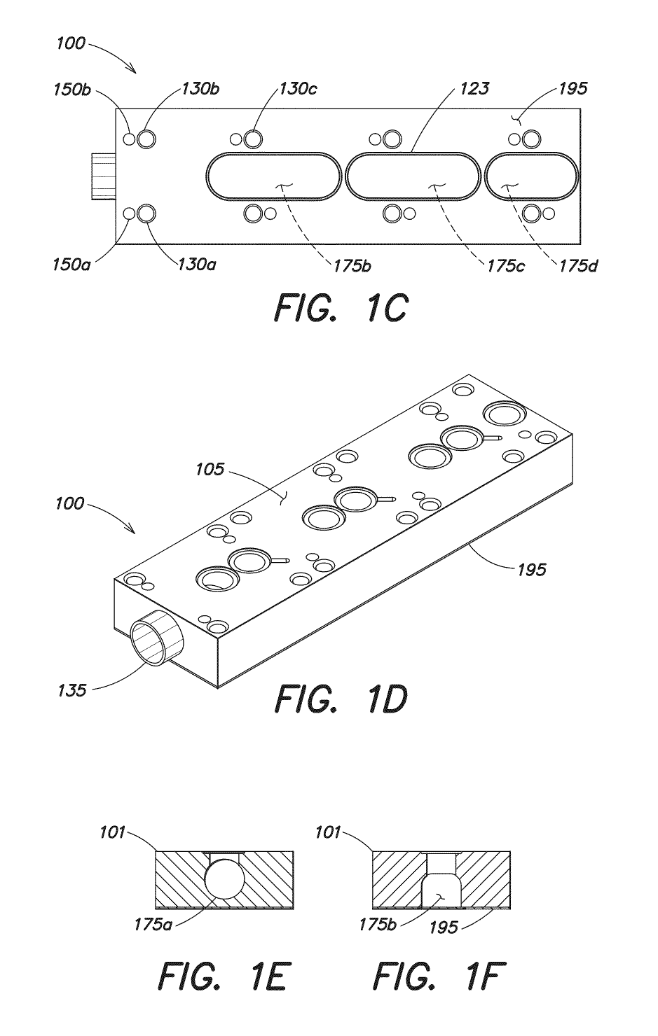

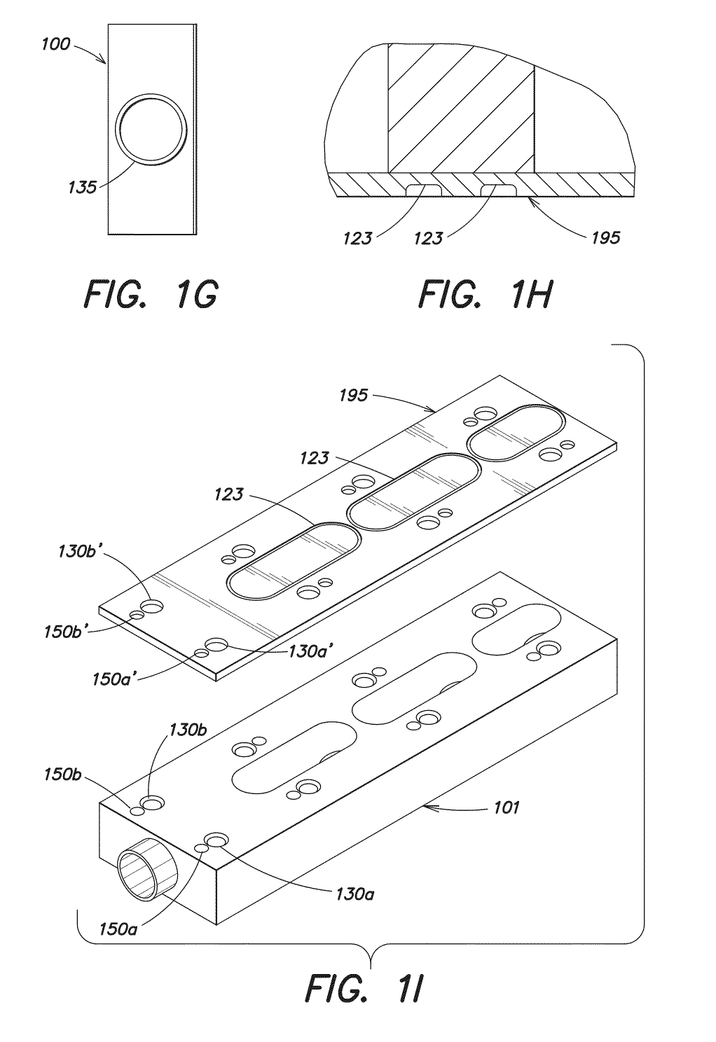

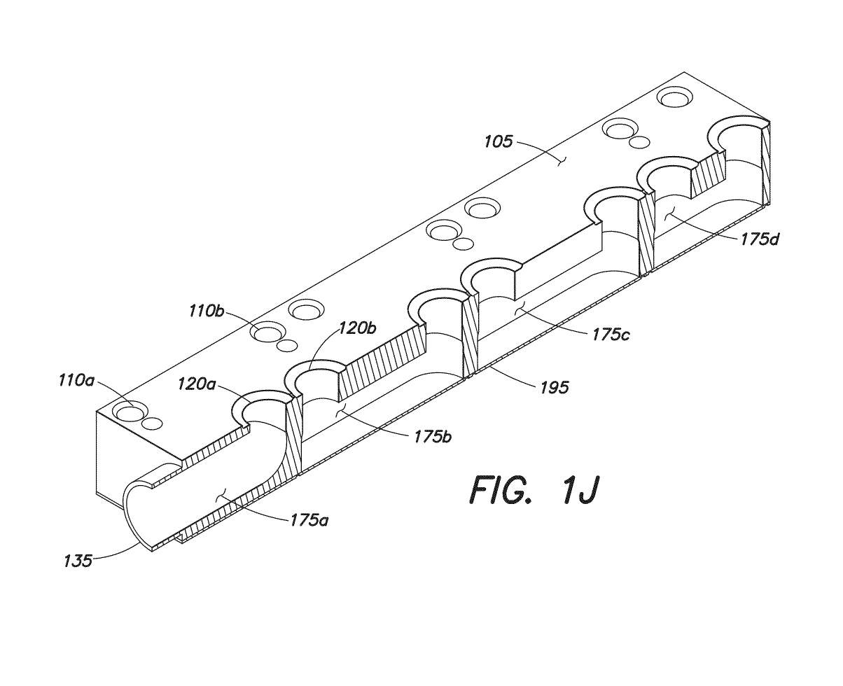

FIGS. 1A-J illustrate a modular flow substrate in accordance with an embodiment of the present invention for use with fluid handling components having asymmetric port placement (e.g., C-seal components) in which one of the ports of the fluid handling component is axially aligned with the center of the component and the other is situated off axis. Although not shown in the figures, it should be appreciated that embodiments of the present invention may be modified for use with fluid handling components have a symmetric port placement, such as W-Seal™ components.

As shown, the flow substrate 100 includes a substrate body 101 formed from a solid block of material and an associated cap 195 (see FIG. 1I), each of which may be formed from a suitable material (such as stainless steel) in accordance with the intended use of the flow substrate. The substrate 100 includes a component attachment surface 105 to which a fluid handling component (such as a valve, pressure transducer, filter, regulator, mass flow controller, etc.) is attached. Formed in the component attachment surface 105 of the flow substrate are one or more component conduit ports 120. Component conduit port 120a would typically be fluidly connected to a first port (inlet or outlet) of a first fluid handling component, while component port 120b would typically be fluidly connected to the second port (outlet or inlet) of the first fluid handling component; component conduit port 120c would typically be fluidly connected to the port (outlet or inlet) of a second fluid handling component that is distinct form the first fluid handling component.

Component conduit ports 120c and 120d and component conduit ports 120e and 120f would each be respectively connected to the inlet and outlet of a respective fluid handling component and illustrate how the flow substrate 100 is specifically suited to fluid handling components having asymmetric port placement. Component port 120g would typically be associated with the inlet or outlet port of a device, such as a mass flow controller, that might be used to communicate the flow of process fluid between flow substrates of a fluid delivery stick.

Associated with component conduit ports 120a and 120b are a plurality of internally threaded component mounting apertures 110a, 110b, 110c, and 110d, each of which would receive the threaded end of a fastener (not shown) that is used to sealingly mount a fluid handling component to the flow substrate 100. Associated with conduit port 120g are a pair of internally threaded component mounting apertures 110y, 110z, each of which would receive the threaded end of a fastener (not shown) to sealingly mount a port of a fluid handling component, such as a mass flow controller to the flow substrate 100. It should be appreciated that an adjacent flow substrate in the fluid delivery stick would typically provide an additional pair of mounting apertures needed to sealingly mount the other port of the fluid handling component to the adjacent flow substrate. Associated with each pair of component conduit ports is a leak port 125a (for component conduit ports 120a and 120b), and 125b (for component conduit ports 120c and 120d) that permits any leakage between the conduit ports and the respective fluid handling component to be detected.

The flow substrate 100 includes a number of fluid pathways 175a, 175b, 175c, and 175d that are used to convey fluid in a longitudinal direction (i.e., from left to right in FIG. 1A) along the flow substrate 100. For example, fluid pathway 175a extends between a tube stub connection 135 and component conduit port 120a, fluid pathway 175b extends between component conduit ports 120b and 120c, fluid pathway 175c extends between component conduit port 120d and component conduit port 120e, and fluid pathway 175d extends between component conduit port 120f and 120g. Tube stub connection 135 would typically be fluidly connected (for example, by welding) to a source or sink of process fluid.

A plurality of dowel pin apertures 150a through 150h are formed in the flow substrate 100 that extend from the component attachment surface 105 through to a connection attachment surface 115 on a side of the flow substrate opposing the component attachment surface 105. The connection attachment surface 115 may be used to connect the substrate 100 to a fluid delivery stick bracket, to a manifold, or both, such as described in Applicant's '854 application. Each of these dowel pin apertures 150a-150h can receive a dowel pin (not shown) that may be used to perform different functions. A first function is to align the cap 195 with the body 101 of the flow substrate 100, and a second is to align the flow substrate with a fluid delivery stick bracket in a manner similar to that described in Applicant's '854 application. It should be appreciated that in certain installations, only the first of these functions may be performed, such that after alignment (and welding as described further in detail below), the dowel pin may be removed and re-used with another flow substrate body and cap. In accordance with a further aspect of the present invention, the location of the dowel pin may be backwards compatible with existing modular flow substrate systems, for example, the K1s system.

FIG. 1C illustrates a view of the flow substrate 100 from below in which a plurality of flow substrate mounting apertures 130 are visible. The plurality of flow substrate mounting apertures 130 are formed in the cap 195 and extend through the cap 195 and into the body 101 of the flow substrate (shown more clearly in FIG. 1I). Within the flow substrate body, the flow substrate mounting apertures 130 are internally threaded to receive a fastener (not shown) to mount the flow substrate 100 to a mounting surface, such as a fluid delivery stick bracket, from below. The placement of the flow substrate mounting apertures 130 may be varied depending upon the placement of mounting apertures in the mounting surface to which the flow substrate 100 is to be attached.

As can be seen in the figures, component conduit ports 120 and fluid pathways 175 are all machined in a cost-effective manner. Thus, component conduit ports 120a-120g may each be formed by machining from the component attachment surface 105 into a first or top surface of the body 101 of the flow substrate 100, fluid pathways 175b, 175c, and 175d may each be respectively formed by machining from a second or bottom surface of the body 101 of the flow substrate as shown in FIG. 1F, and fluid pathway 175a may be formed by machining from a side surface of the body of the flow substrate as shown in FIG. 1E. The fluid pathways 175 may be treated to enhance their corrosion resistance. It should be appreciated that the dimensions of the fluid pathways 175 depicted in the figures are particularly well suited for higher flow rates, such as those above approximately 50 SLM. Indeed, the dimensions of the fluid pathways depicted in the figures permit the flow substrate 100 to be used in high flow rate applications (e.g., between approximately 50-100 SLM) as well as very high flow rate applications (e.g., those above approximately 200 SLM). Thus, embodiments of the present invention may be used with emerging semiconductor manufacturing equipment that is designed to operate at very high flow rates between approximately 200 SLM to 1000 SLM. It should be appreciated that the dimensions of the fluid pathways may be scaled down for lower flow applications in a straight-forward manner, for example, simply by reducing the cross-sectional area of one or more of the fluid pathways 175b, 175c, and 175d. Indeed, because the component conduit ports 120 are formed in a to different process step than the fluid pathways, the dimensions of the fluid pathways are not constrained by the dimensions of the component conduit ports, and thus, the cross-sectional area of the fluid pathways may be significantly larger, smaller, or the same as that of the component conduit ports to accommodate a wide range of flow rates.

FIGS. 1H and 1I illustrate various details of the cap 195 in accordance with an aspect of the present invention. In accordance with one embodiment that is specifically adapted for use with semiconductor process fluids that may frequently be heated to a temperature above ambient, the cap 195 is formed from a thin sheet of stainless steel approximately 0.02 inches (0.5 mm) thick. The thinness of the sheet of stainless steel permits heat to be readily transferred to the process fluids flowing in the flow substrate by application of heat to the connection attachment surface 115 of the substrate. The source of heat may be provided by a block heater, by a cartridge heater inserted into a groove of a fluid delivery stick bracket to which the flow substrate is attached in a manner similar to that described in Applicant's '854 application, or by a thin film heater, such as that described in U.S. Pat. No. 7,307,247. It should be appreciated that the thinness of the cap also permits fluid flowing in the flow substrate to be cooled, should that be desired.

In accordance with one aspect of the present invention, the sheet of stainless steel may be chemically etched to form grooves 123 that surround and define the fluid pathways 175b, 175c, and 175d. Such chemical etching may be accurately performed, and can be less expensive than other method of forming grooves, such as by machining, which may alternatively be used. The grooves 123 may define weld formations (i.e., weld preparations) in a surface of the cap 195. In accordance with one embodiment, the grooves may be etched to a thickness of approximately 0.01 inches (0.25 mm). The presence of the grooves 123 surrounding and defining each fluid pathway 175b, 175c, and 175d serves a number of purposes. For example, the thinness of the grooves permits the cap to be welded to the body 101 of the flow substrate, for example, by electron beam welding, using less time and energy than if the grooves 123 were not present. The welding would be performed by tracing around each fluid pathway defined by the groove, thereby forming a fluid tight seal. The electron beam welding may be performed in a vacuum environment to minimize any contamination. Where the materials being used for the flow substrate body 101 and cap 195 are high purity metals, such as stainless steel, the vacuum welding environment acts to further eliminate contaminants (such as Carbon, Sulfur, Manganese, etc.) at the point of the weld. Although electron beam welding is generally preferred, it should be appreciated that other types of welding, such as laser welding may also be used.

The presence of the grooves 123 also serves as a guide during welding, since the grooves define the periphery of the fluid pathway. Dowel pin holes 150a, 150b in the body 101 of the flow substrate and corresponding dowel pin holes 150a′, 150b′ in the cap 195 receive a dowel pin that permits the cap 195 to be aligned with and held in registration with the body of the flow substrate 100 during welding. The dowel pins may be removed and re used after welding is complete, or kept in place as an aid for aligning the flow substrate with a mounting surface.

It should be appreciated that although only four fluid pathways are illustrated in the figures, the ease and low cost of manufacturing embodiments of the present invention readily permits any number of fluid pathways and component ports to be defined in the flow substrate. In this regard, all of the fluid pathways and component connection ports for an entire fluid delivery stick may be formed in a single flow substrate. Alternatively, a fluid delivery stick may be formed by using two or more flow substrates such as the flow substrate 100 described above.

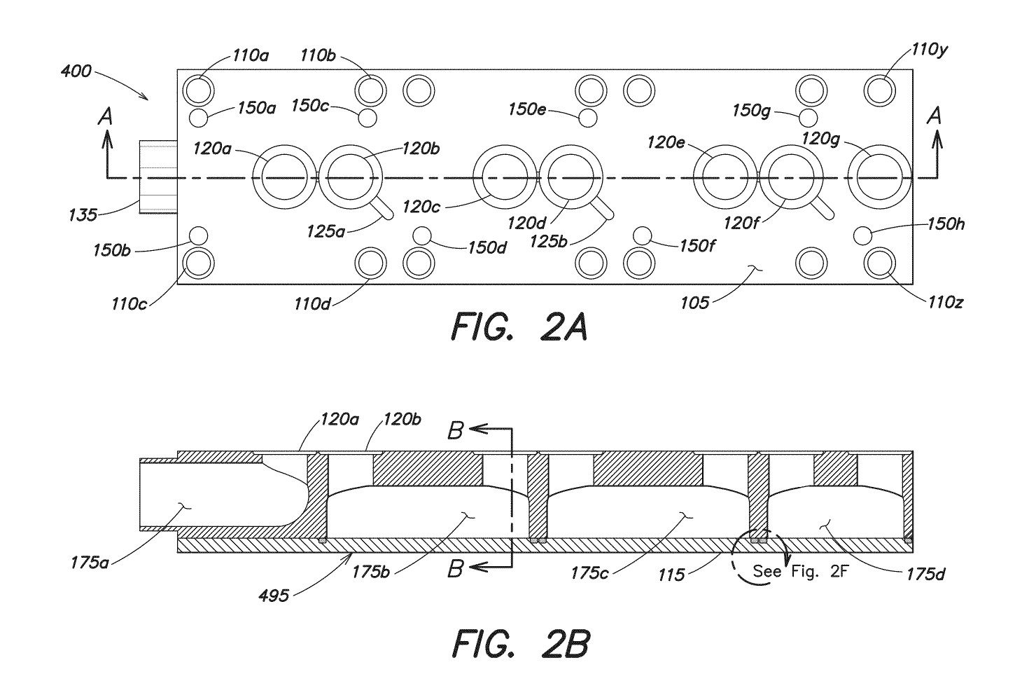

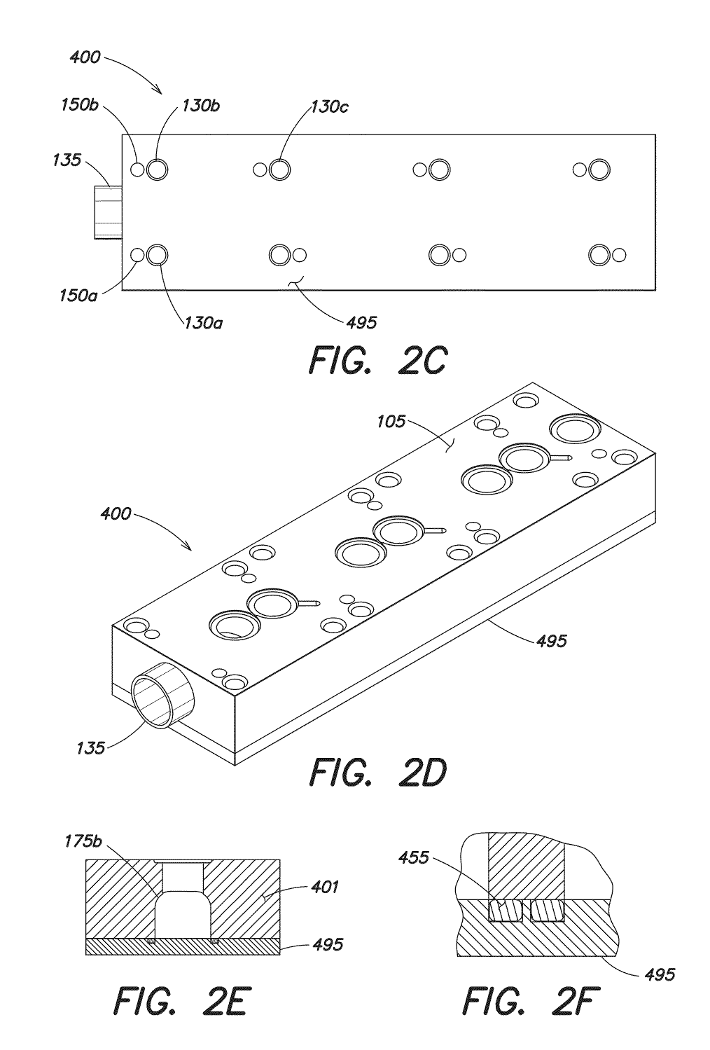

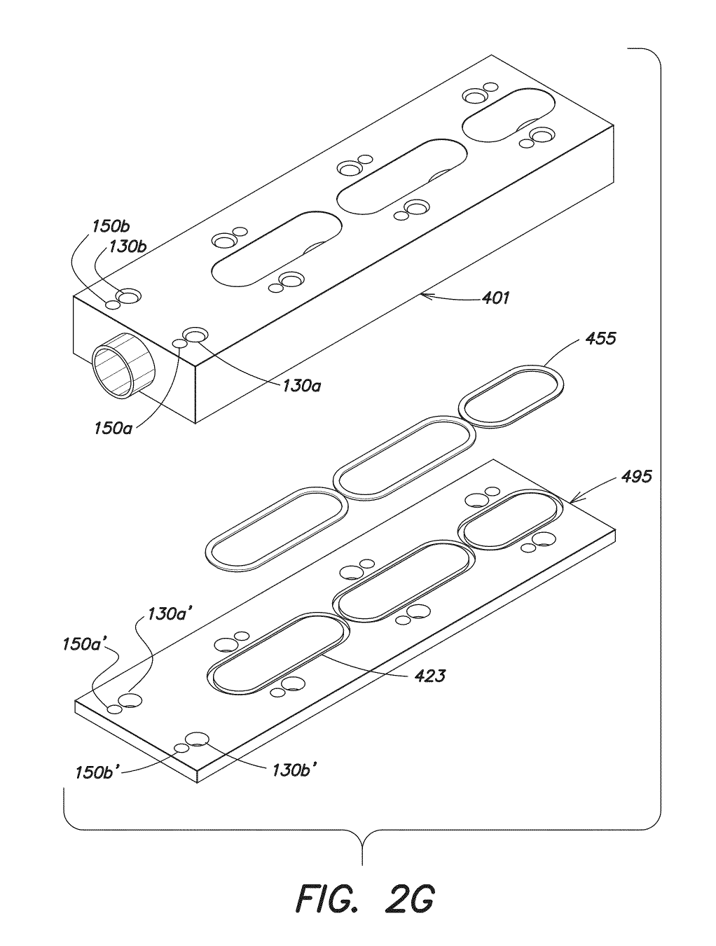

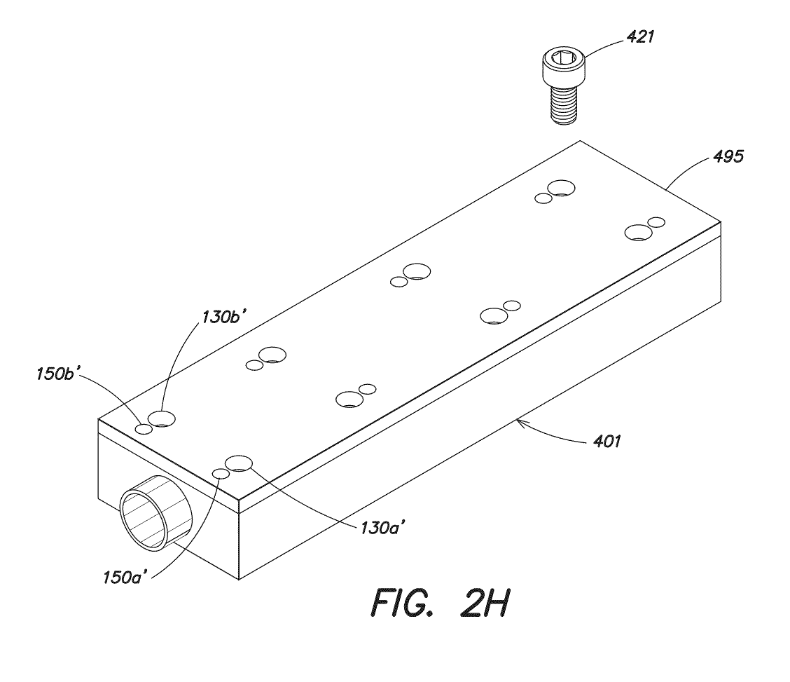

FIGS. 2A-H illustrate a modular flow substrate in accordance with another embodiment of the present invention. Like the first embodiment, this embodiment is specifically adapted for use with fluid handling components having asymmetric port placement (e.g., C-seal components) in which one of the ports of the fluid handling component is axially aligned with the center of the component and the other is situated off axis. Although not shown in the figures, it should be appreciated that this embodiment, like the previous embodiment, may be modified for use with fluid handling components have a symmetric port placement, such as W-Seal™ components. This second embodiment, like the first, is specifically adapted for use in higher volume (i.e., higher flow rate) applications, but may be adapted for use in lower volume applications, such as those below approximately 50 SCCM, as well. As this second embodiment shares many similar design aspects as the first, only differences are described in detail below.

As shown, the flow substrate 400 includes a substrate body 401 formed from a solid block of material and an associated cap 495 (see FIG. 2G), each of which may be formed from a suitable material (such as stainless steel) in accordance with the intended use of the flow substrate. Primarily for cost reasons, but also for those applications that warrant the use of non-metallic materials (such as where ionic contamination is a concern), the body 401 and/or cap 495 of the flow substrate may also be formed (e.g., molded or machined) from polymeric materials, such as plastic. The use of other materials, such as plastic, permits the flow substrate 400 to be particularly well suited to chemical delivery applications or biological applications where ionic contamination is a concern, and/or applications where cost is a concern.

As in the first embodiment, flow substrate 400 includes a component attachment surface 105 to which a fluid handling component (such as a valve, pressure transducer, filter, regulator, mass flow controller, etc.) is attached. Formed in the component attachment surface 105 of the flow substrate 400 are one or more component conduit ports 120, having similar functionality as that described with respect to the first embodiment. Associated with each of the component conduit ports 120 are a plurality of internally threaded component mounting apertures 110a, 110b, 110c, 110d, 110y, and 110z, each of which would receive the threaded end of a fastener (not shown) that is used to sealingly mount a fluid handling component (not shown) to the flow substrate 400 in a manner similar to that described previously. Associated with each pair of component conduit ports is a leak port 125a (for component conduit ports 120a and 120b), and 125b (for component conduit ports 120c and 120d) that permits any leakage between the conduit ports and the respective fluid handling component to be detected.

As in the first embodiment, the flow substrate 400 includes a number of fluid pathways 175a, 175b, 175c, and 175d that are used to convey fluid in a longitudinal direction (i.e., from left to right in FIG. 2A) along the flow substrate 400. As previously described, tube stub connection 135 would typically be fluidly connected (for example, by welding, or by using a suitable adhesive, such as an epoxy) to a source or sink of process fluid.

As in the first embodiment, a plurality of dowel pin apertures 150a through 150h are formed in the flow substrate 400 that extend from the component attachment surface 105 through to a connection attachment surface 115 on a side of the flow substrate opposing the component attachment surface. The connection attachment surface 115 may be used to connect the substrate 400 to a fluid delivery stick bracket, to a manifold, or both, such as described in Applicant's '854 application.

As described previously, each of these dowel pin apertures 150a-150h can receive a dowel pin (not shown) that may be used to perform different functions. A first function is to align the cap 495 with the body 401 of the flow substrate 400, and a second is to align the flow substrate with a fluid delivery stick bracket in a manner similar to that described in Applicant's '854 application. It should be appreciated that in certain installations, only the first of these functions may be performed. For example, depending on the length of the dowel pin used, the dowel pin may protrude through the cap 495 and extend beyond connection attachment surface 115, such that the dowel pins may be used to align the flow substrate with corresponding apertures in the fluid delivery stick bracket or other mounting surface. Where the dowel pins extend beyond the connection attachment surface 115, the locations of the dowel pins may be backwards compatible with existing modular flow substrate systems. Alternatively, the length of the dowel pin may be such that it does not extend beyond the connection attachment surface, but still engages the cap 495 to ensure alignment.

FIG. 2C illustrates a view of the flow substrate 400 from below in which a plurality of flow substrate mounting apertures 130 are visible. The plurality of flow substrate mounting apertures 130 are formed in the cap 495 and extend through the cap 195 and into the body 401 of the flow substrate (shown more clearly in FIG. 2G). Within the flow substrate body, the flow substrate mounting apertures 130 (130a, 130b in FIG. 2G) are internally threaded to receive a fastener 421 (FIG. 2H) to mount the flow substrate 400 to a mounting surface, such as a fluid delivery stick bracket, from below. The fasteners 421 are also used to compress a deformable gasket 455, such an elastomeric o-ring to form a seal around each respective fluid pathway 175b, 175c, and 175d, as described further below. As can be seen in the figures, component conduit ports 120 and fluid pathways 175 can again be machined or molded in a cost-effective manner.

FIGS. 2D-H illustrate various details of the cap 495 in accordance with an aspect of the present invention. As shown in FIGS. 2B and 2E, the thickness of the cap 495 is considerably thicker than that of the first embodiment (e.g., 0.13 inches (3.3 mm) versus 0.02 inches (0.5 mm)) making it somewhat less effective at transferring heat, or cooling to the fluid flowing in the flow substrate, particularly where the cap 495 and body 401 of the flow substrate 400 are formed from relatively non-conductive materials, such as plastic, and where heating (or cooling) is provided to the exposed surface 115 from below. However, the thickness of the cap 495 permits the cap 495 to be sufficiently rigid so as to permit it to act as its own mounting surface, and permits grooves 423 to be formed therein that are sufficiently deep so as to retain an elastomeric seal 455. In further contrast to the cap 195 of the first embodiment, and as shown most clearly in FIG. 2G, the grooves 423 are machined in the surface of the cap 495 that is to be placed in registration with the body 401 of the flow substrate (i.e., the unexposed surface of the cap 495 when placed in registration with the body 401 of the substrate 400, rather than the exposed surface 115 that would be placed in registration with a fluid delivery stick bracket or other mounting surface as in the first embodiment). The grooves 423 are dimensioned so as to retain the elastomeric seal 455 in place during assembly of the cap 495 to the body 401 of the flow substrate 400 without the use of additional seal retainers. During assembly and with specific reference to FIG. 2G, the elastomeric seals 455 would be positioned in the grooves 423 defined in a top surface of the cap 495, with the top surface of the cap 495 being placed in registration with the body 401 of the substrate so that dowel pin aperture 150a′ in the cap 495 is aligned with dowel pin aperture 150a in the body 401, dowel pin aperture 150b′ in the cap is aligned with dowel pin aperture 150b in the body 401, and substrate mounting apertures 130a′ and 130b′ in the cap 495 are aligned with substrate mounting apertures 130a and 130b in the body 401, respectively. Although the grooves 423 of this embodiment are described as being machined in the surface of the cap, it should be appreciated that may be formed by other processes, such as by molding.

As can be seen in FIG. 2H, a plurality of fasteners 421 are used to secure the cap 495 to the body 401 of the flow substrate 400. These fasteners 421 may serve two purposes: to mount the flow substrate 400 to a fluid delivery stick bracket from below; and to compress the elastomeric seals 455 and ensure a fluid tight seal around the periphery of the fluid pathways 175b-d. In use, the elastomeric seals 455 would typically be placed in position in the grooves 423 of the cap 495. The cap would then be aligned with the body 401 of the flow substrate 400, aided by the dowel pins inserted in dowel pin apertures 150, where the dowel pins extending through dowel pin apertures 150a′, 150b′, etc. of the cap 495 act to secure the cap 495 and elastomeric seals 455 in place with the substrate body 401 of the flow substrate 400, thereby forming a single unit. The flow substrate 400 would then be placed in the desired position on the fluid delivery stick bracket or other mounting surface, and the fasteners 421 inserted from below the bracket or other mounting surface. Tightening of the fasteners 421 secures the flow substrate to the mounting surface, and compresses the elastomeric seals 455 so that a fluid tight seal is formed around the periphery of the fluid pathway, and the cap 495 is in registration with the body 401 of the flow substrate 400.

It should be appreciated that because the cap 495 is not welded to the body 401 of the flow substrate 400, the cap 495, and the associated elastomeric seals 455 may later be removed with a minimal amount of effort. Thus, for example, where it is desired to clean or otherwise service a fluid pathway 175b, 175c, or 175d, the cap 495 may be easily removed to expose and/or clean the fluid pathways, to replace one or more of the elastomeric seals 455, etc.

It should be appreciated that although only four fluid pathways are illustrated in the figures associated with this second embodiment, the ease and low cost of manufacturing embodiments of the present invention readily permits any number of fluid pathways and component ports to be defined in the flow substrate. In this regard, all of the fluid pathways and component connection ports for an entire fluid delivery stick or chemical or biological delivery system may be formed (by machining, by molding, or a combination of molding and machining) in a single flow substrate.

Although the embodiment depicted in FIGS. 2A-H may not be as effective at transferring thermal energy (heating or cooling) to the fluid flowing in the flow substrate when heated or cooled from below, it should be appreciated that this second embodiment may be modified for such use. For example, the thickness of the cap 495 may be increased so as to permit the formation of longitudinal heater apertures and the insertion of one or more cartridge type heaters therein that directly heat the cap 495, and thus the fluid flowing in the fluid pathways 175. Such a modification may be used even where the body 401 of the flow substrate is formed from a non-conductive material, such as plastic. For example, to further improve thermal conductivity, the cap 495 may be formed from a thermally conductive material, such as aluminum, while the body 401 of the flow substrate is formed from a different material, e.g., plastic.

Although not specifically illustrated, it should be appreciated that other aspects described in Applicant's '854 application may be adapted for use with the flow substrate described herein. For example, in addition to fluid pathways oriented in a longitudinal direction, the flow substrate may include a manifold fluid pathway oriented in a transverse direction. In such an embodiment, a tube stub connection similar to the tube stub connection 135 could extend from a lateral side surface of the body 101 (401) of the flow substrate, with the manifold fluid pathway being formed in a manner similar to that described with respect to fluid pathway 175a.

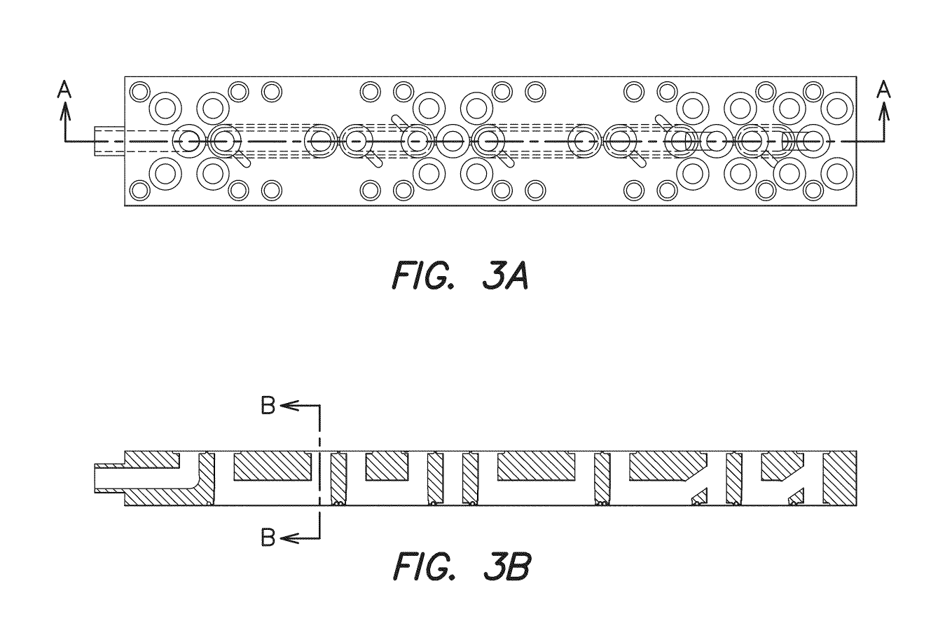

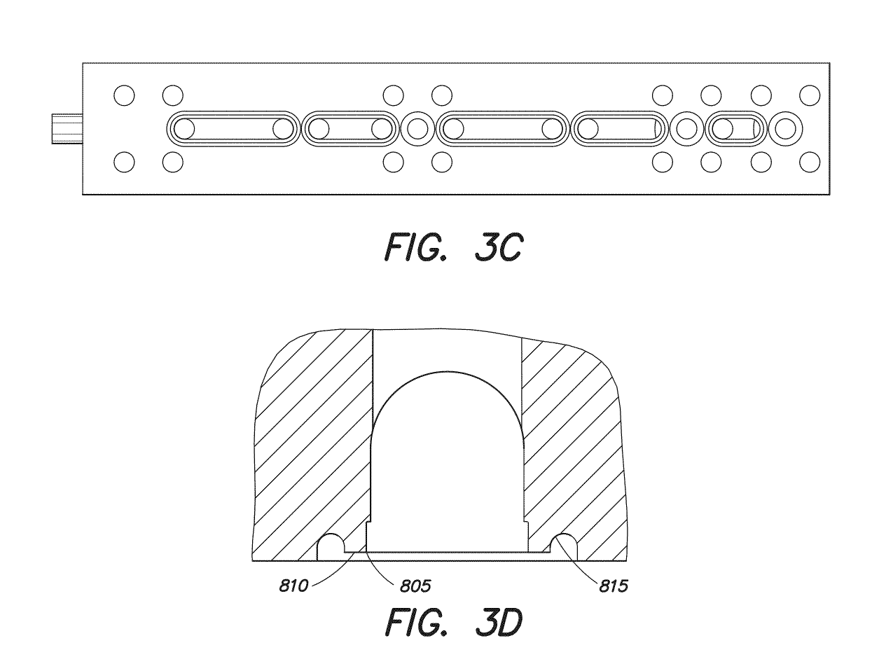

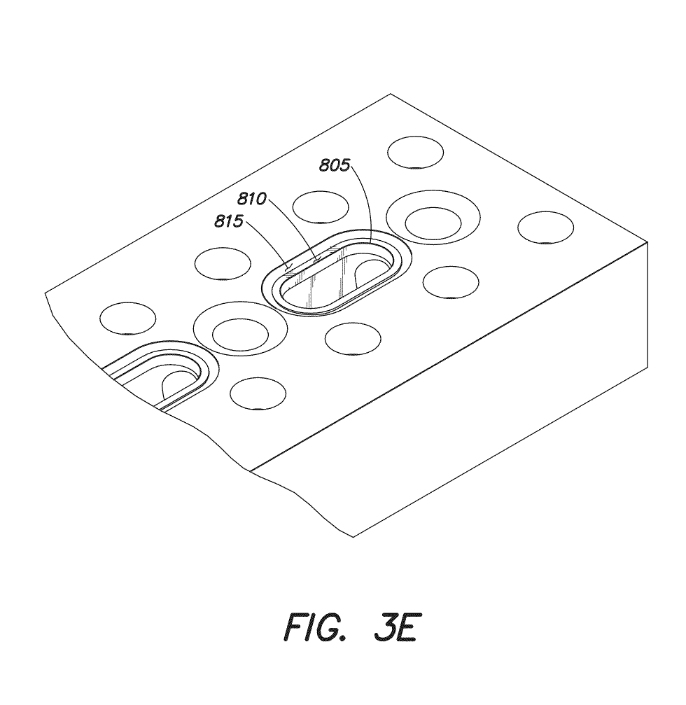

Although embodiments of the present invention have been described primarily with respect to the use of fluid handling components having two ports, it should be appreciated that embodiment of Applicant's invention could be modified for use with a three-port component, such as a 3-port valve as illustrated in FIGS. 3A and 3C. However, because such fluid handling components are less common, and typically more expensive, two-port fluid handling components are generally preferred.

The embodiments of FIGS. 1 and 2 described above are directed to flow substrates in which a plurality of fluid pathways formed within the substrate body are sealed by a common or integrated cap that is attached to the bottom surface of the substrate body. The embodiment of FIGS. 1A-J uses an integrated cap that is welded to the bottom surface of the flow substrate around each of the fluid pathways to seal each of the fluid pathways, while the embodiment of FIGS. 2A-H use an integrated cap that, when compressed against the bottom surface of the substrate body, compresses a plurality of elastomeric seals disposed around each of the fluid pathways to seal each of the fluid pathways. In accordance with another aspect of Applicant's invention, rather than using an integrated cap to seal each of a plurality of fluid pathways in a flow substrate as shown in FIGS. 1 and 2, a plurality of individual caps may alternatively be used. Embodiments of Applicant's invention that use a plurality of individual caps are now described with respect to FIGS. 3-12.

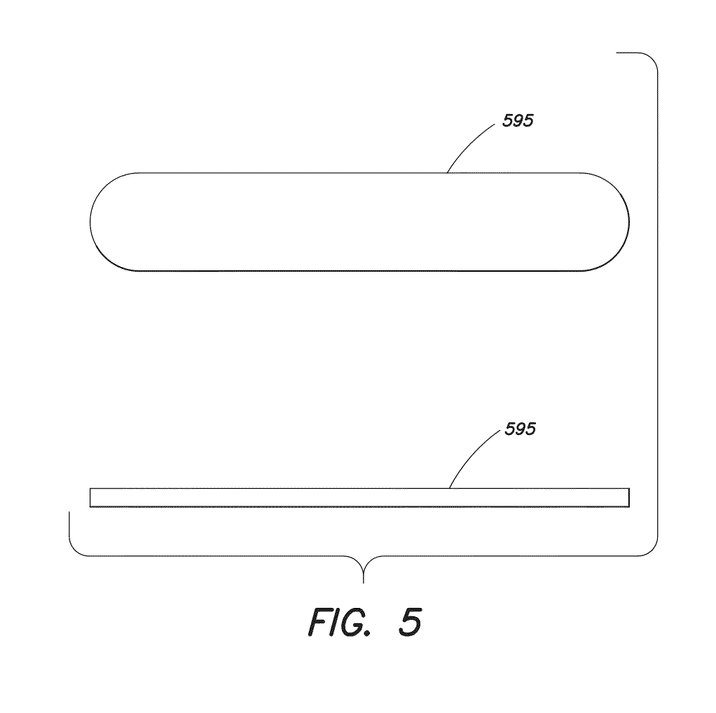

FIGS. 3A-E are directed to a flow substrate that includes a plurality of associated caps, with each cap being associated with a respective fluid pathway formed in the body of the flow substrate. The caps may be similar in structure to the cap 595 shown in FIG. 5, and are recessed within the body of the substrate and then seam welded in place. The caps may be formed, for example, by stamping or by machining a piece of metal, for example, stainless steel. FIGS. 3A-C illustrate that in addition to being able to accommodate fluid handling components with two ports, certain embodiments of the present invention may be modified to accommodate fluid handling components having three ports.

As can best be seen in FIGS. 3D and 3E, each of the fluid pathways is surrounded by a weld formation (also called a weld preparation) that includes a weld edge 805, a stress relief wall 810 and a stress relief groove 815. The stress relief groove 815 acts to prevent any bowing, twisting, or other distortion that might occur during seam welding of the cap 595 to the body of the flow substrate along the weld edge 805, and the exposed surface of the weld cap 595 fits within the body of the flow substrate. Although the welding of the cap to the body of the substrate will typically leave a small bump at the weld location, no additional surface preparation is required to remove this bump because it does not extend beyond the bottom surface of the body of the flow substrate and may be left in place.

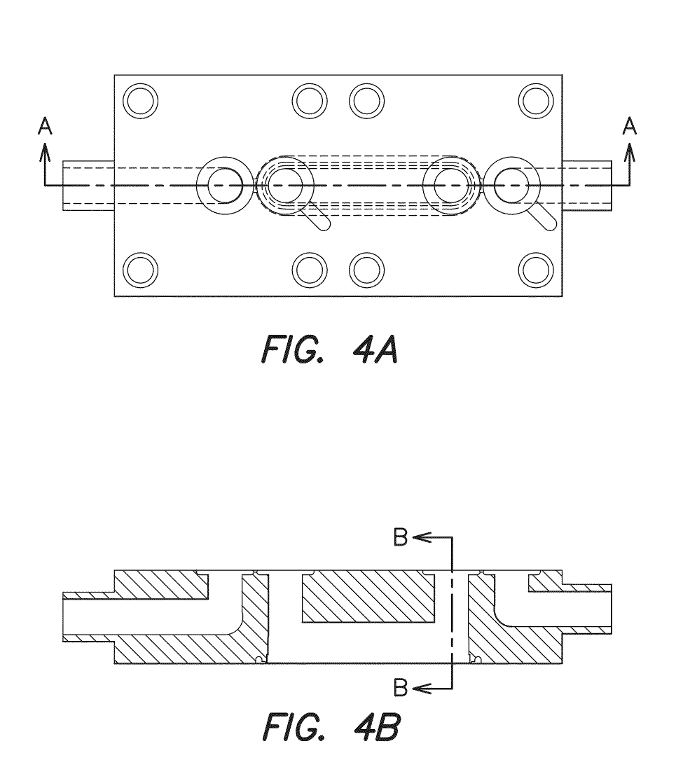

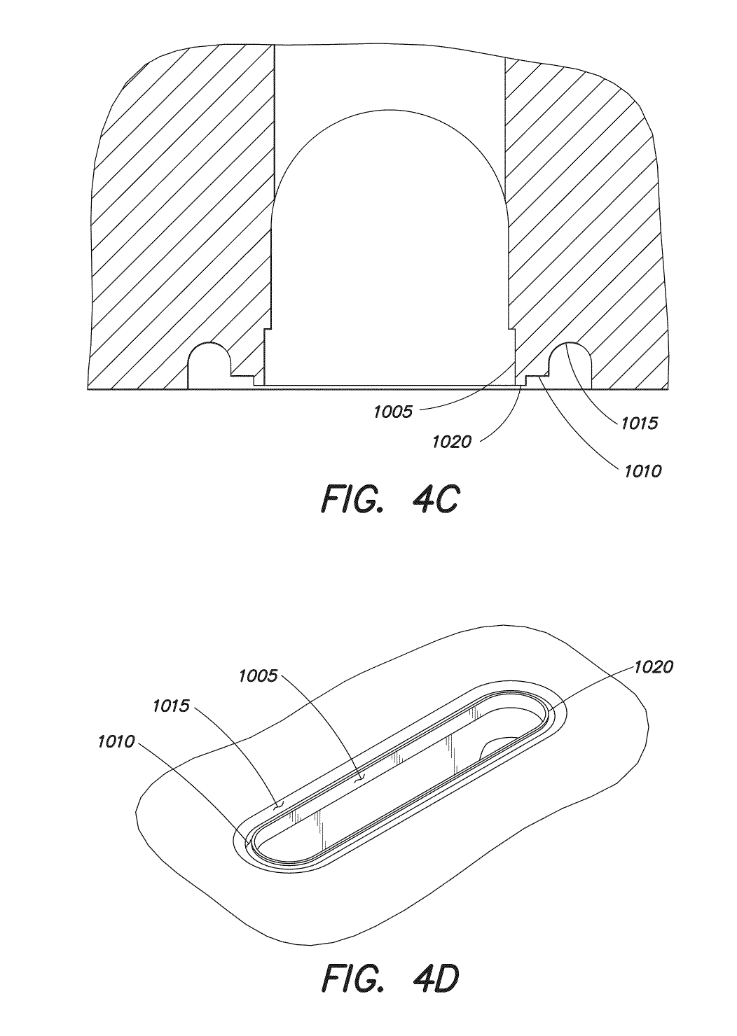

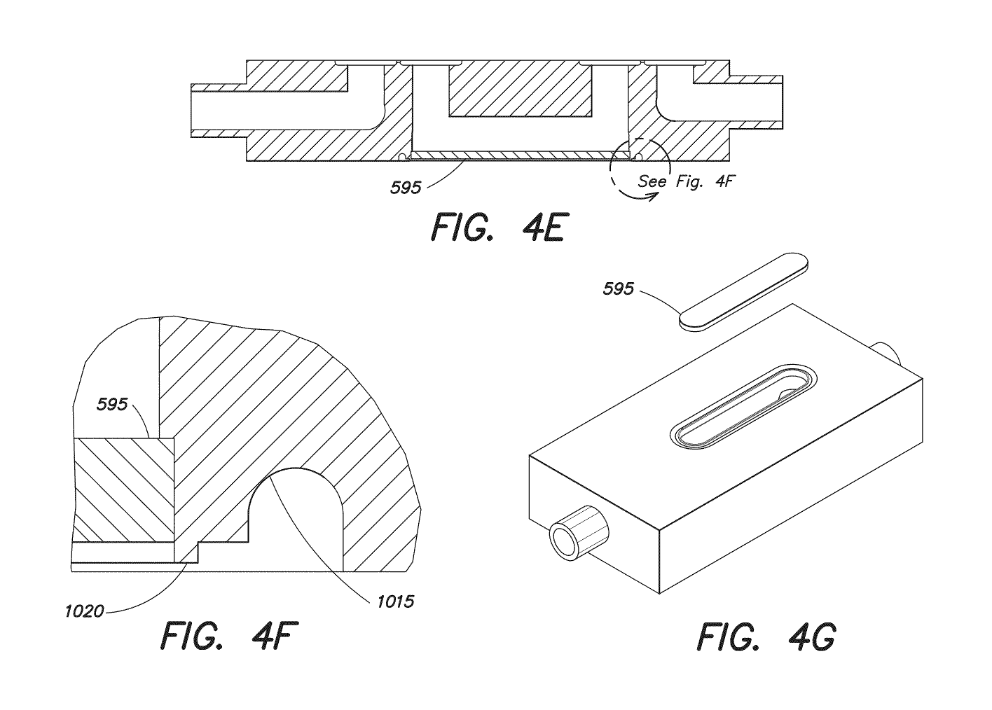

FIGS. 4A-G illustrate an alternative design of a flow substrate in accordance with the present invention that also includes a fluid pathway that is sealed by a corresponding individual cap. It should be appreciated that although FIGS. 4A-G illustrate only a single fluid pathway interconnecting two component conduit ports formed in a component attachment surface of the substrate, the substrate body may include a plurality of fluid pathways similar to those shown in FIGS. 3A-E, as FIGS. 4A-G illustrated herein are primarily used to detail the structure of the weld formation used in this particular embodiment. The cap that is used in this embodiment may be formed from a piece or sheet of metal, such as by stamping or machining, as illustrated in FIG. 5.

As best illustrated in FIG. 4C, the weld formation includes a weld edge 1005, a stress relief wall 1010 and a stress relief groove 1015, each performing a function similar to that described above with respect to FIGS. 3A-E. However, in contrast to the embodiment of FIGS. 3A-E, the embodiment depicted in FIGS. 4A-G also includes a swaged lip 1020. During manufacture, after placing a respective cap 595 (FIG. 5) in each of the fluid pathways to be sealed, a mechanical force would be applied to the swaged lip 1020 surrounding each fluid pathway, for example, using a die or jig built for this purpose. The mechanical force applied to the die or jig pushes or folds (i.e., swages) the lip inward toward the weld edge to capture and retain the respective cap 595 within the body of the flow substrate. The substrate with its associated retained cap(s) may then be manipulated as a single unit. Each respective cap may then be seam welded along the folded swaged lip and weld edge to form a leak tight seal. As in the embodiment of FIGS. 3A-E, no additional surface preparation or machining is required to remove any weld bump that might be formed along the weld edge, because it does not extend beyond the bottom surface of the substrate body. As in the previous embodiment of FIGS. 3A-E, the stress relief groove acts to prevent any bowing, twisting, or other distortion that might occur during seam welding of the cap 595 to the body of the flow substrate along the weld edge 1005

FIG. 5 illustrates a cap 595 that may be used with the embodiments of FIGS. 3-4. Advantageously, the cap 595 may be machined or stamped from a sheet of metal at very low cost. The thickness of the cap 595 in one embodiment of the present invention is approximately 0.035 inches (0.9 mm) thick, nearly twice the thickness of the integrated weld cap 195, and requires no additional reinforcement even in high pressure applications.

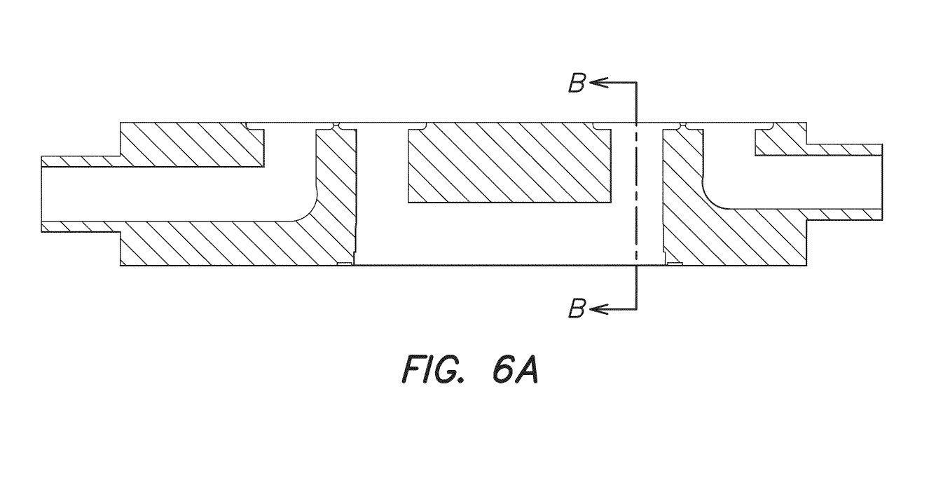

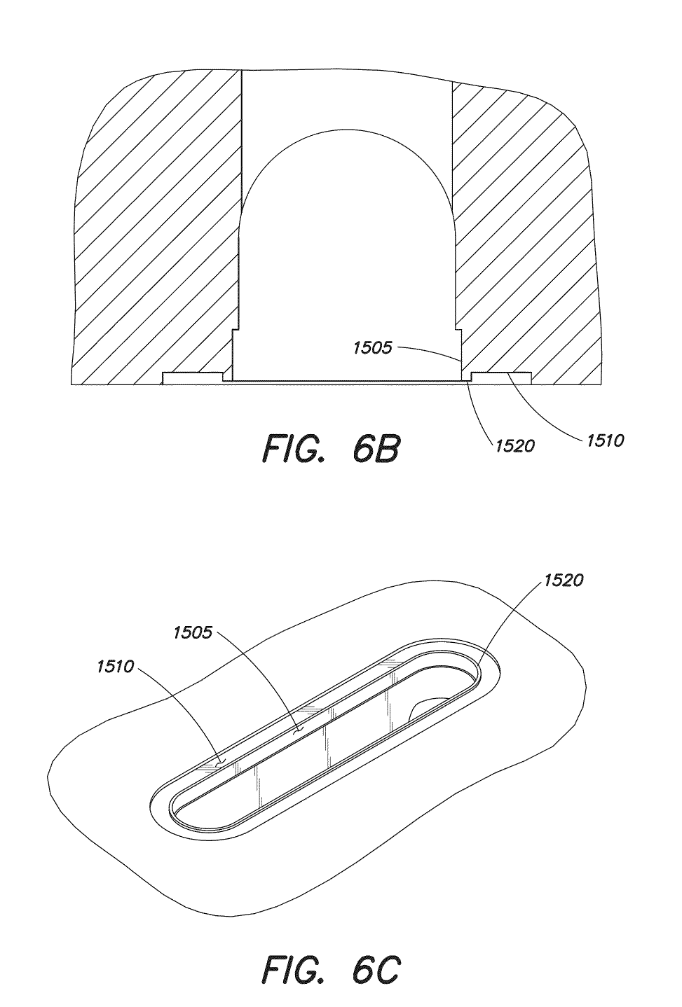

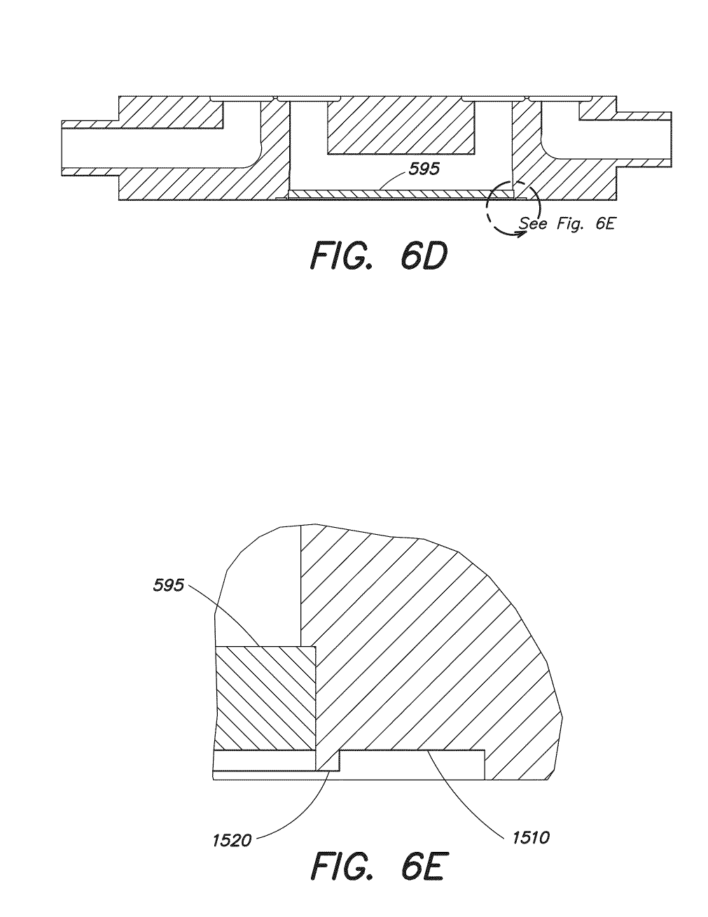

FIGS. 6A-E illustrate yet an alternative design of a flow substrate in accordance with the present invention that includes a fluid pathway sealed by a corresponding individual cap. As in the embodiment of FIGS. 3A-E, it should be appreciated that the substrate body may include a plurality of fluid pathways similar to those shown in FIGS. 3A-E, as FIGS. 6A-E illustrated herein are primarily used to detail the structure of the weld formation used in this particular embodiment. The cap 595 that is used in this embodiment may be the same as that described with respect to FIG. 5 above, and may be formed from a piece or sheet of metal, such as by stamping or machining, as illustrated in FIG. 5.

As best illustrated in FIG. 6B, the weld formation of this embodiment is substantially similar to that described above with respect to FIGS. 4A-G, and includes a weld edge 1505, a recessed flat bottom 1510, and a swaged lip 1520. As in the embodiment of FIGS. 4A-G, a respective cap 595, such as that shown in FIG. 5, may be seam welded to seal each respective fluid pathway. However, the weld formation of this embodiment does not include a stress relief groove as in the embodiment of FIGS. 4A-G. Although the stress relief groove of FIGS. 3A-E and 4A-G helps prevent any deformation of the body of the flow substrate during welding, its presence is not strictly necessary, as seam welding processes generally transfer less heat to the body of the substrate than other types of welding processes, such as stake welding. Accordingly, where cost is a significant concern, the stress relief groove may be omitted as shown with respect to this embodiment. As in the embodiments of FIGS. 3A-E and 4A-G, no additional surface preparation or machining is required to remove any weld bump that might be formed along the weld edge, because it does not extend beyond the bottom surface of the substrate body.

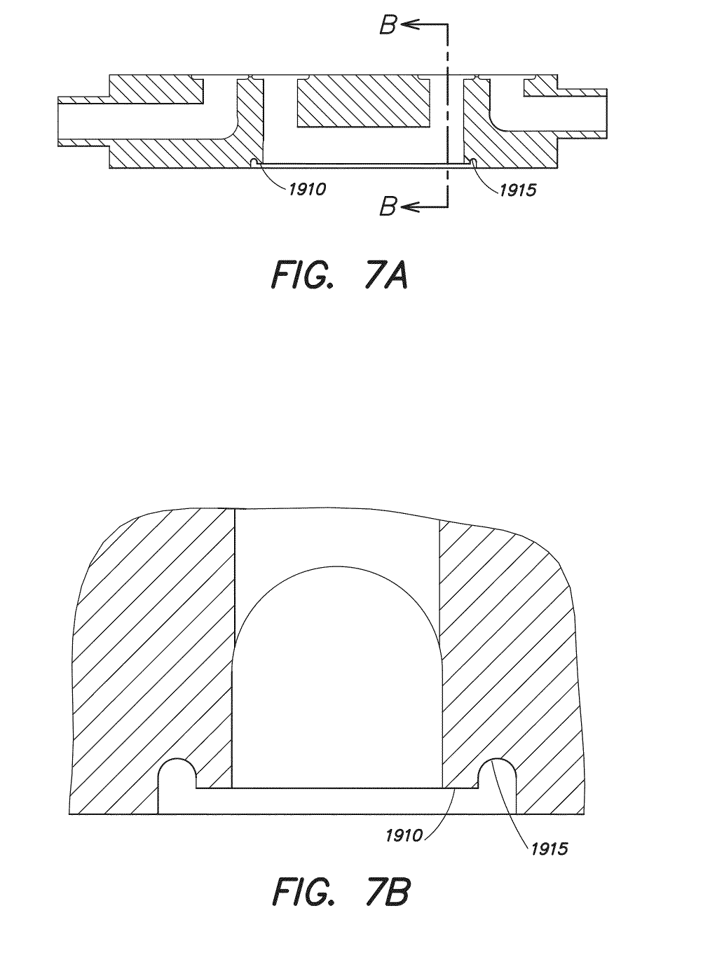

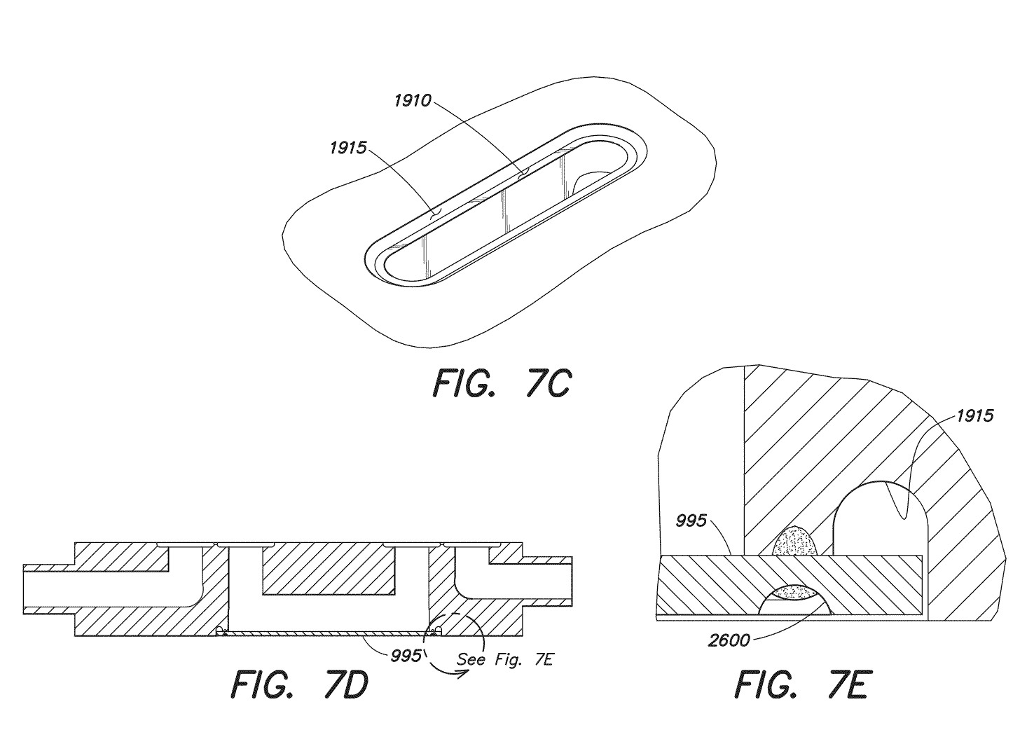

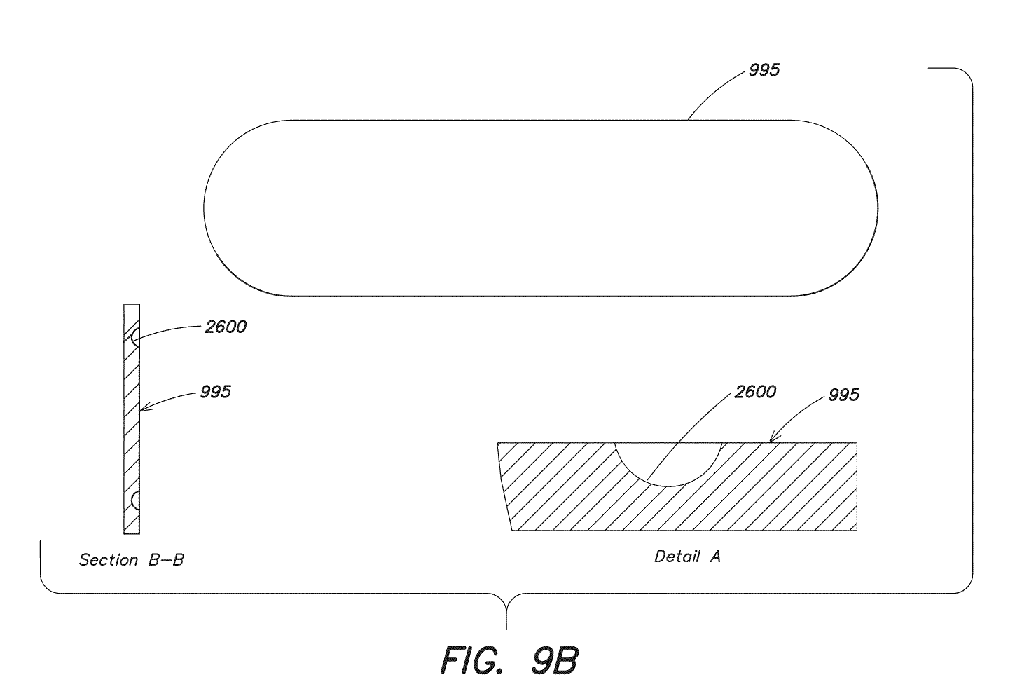

FIGS. 7A-E and 8A-E illustrate alternative embodiments of the present invention that also use individual caps to seal respective fluid pathways formed in the bottom surface of the body of the flow substrate. Each of the embodiments of FIGS. 7A-E and 8A-E use a weld cap (depicted in FIGS. 9A-B) in which a weld formation (i.e., weld preparation) in the form of a heat penetration groove 2600 is formed around a periphery of the cap 995. It should be appreciated that although FIGS. 7A-E and 8A-E illustrate only a single fluid pathway to be sealed by a respective cap, the substrate body may include a plurality of fluid pathways similar to those shown in FIGS. 3A-E as FIGS. 7A-E and 8A-E are shown herein primarily to detail the structure of the weld formations used in these particular embodiments.

As best illustrated in FIG. 7B, the embodiment of FIGS. 7A-E includes a weld formation formed in the body of the flow substrate that includes a stress relief wall and weld surface 1910 and a stress relief groove 1915. The stress relief groove 1915 again acts to prevent any bowing, twisting, or other distortion that might occur during welding of the cap to the body of the flow substrate. However, in the embodiment of FIGS. 7A-E, the cap is stake welded to the stress relief wall and weld surface 1910 along the heat penetration groove 2600 formed in the cap 995 (FIGS. 9A-B). During manufacture, after placing a respective cap 995 over each of the fluid pathways to be sealed, each respective cap would be staked to the stress relief wall and weld surface 1910. This staking may be performed by welding the cap 995 to the stress relief wall and weld surface 1910 at a number of discrete locations along the periphery of the fluid pathway, or by mechanical force, for example, by using a punch to stake the cap 995 to the stress relief wall and weld surface 1910 at a number of discrete locations. The staking permits the substrate with its associated retained cap(s) to be manipulated as a single unit and prevents movement of the cap 995 during welding. Each respective cap 995 may then be stake welded along the heat penetration groove 2600 to form a continuous weld seal. As described in more detail below with respect to FIGS. 9A-B, the heat penetration groove 2600 permits the cap 995 to be welded to the substrate using less energy, more quickly, and with less deformation to the substrate body than were it not present. FIG. 7E illustrates the manner in which the weld penetrates the body of the substrate.

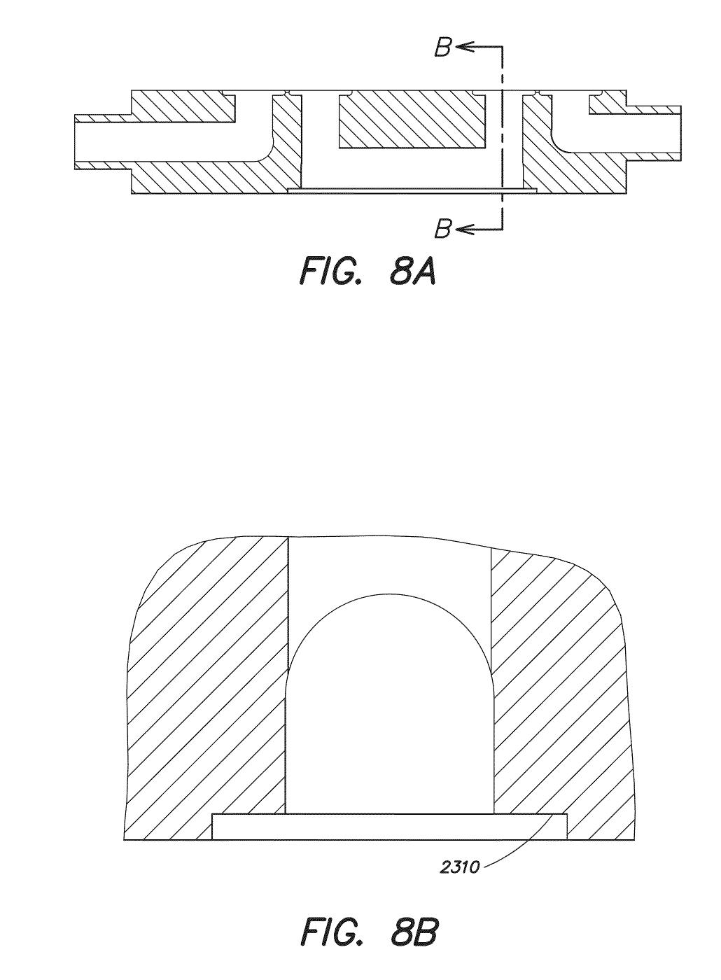

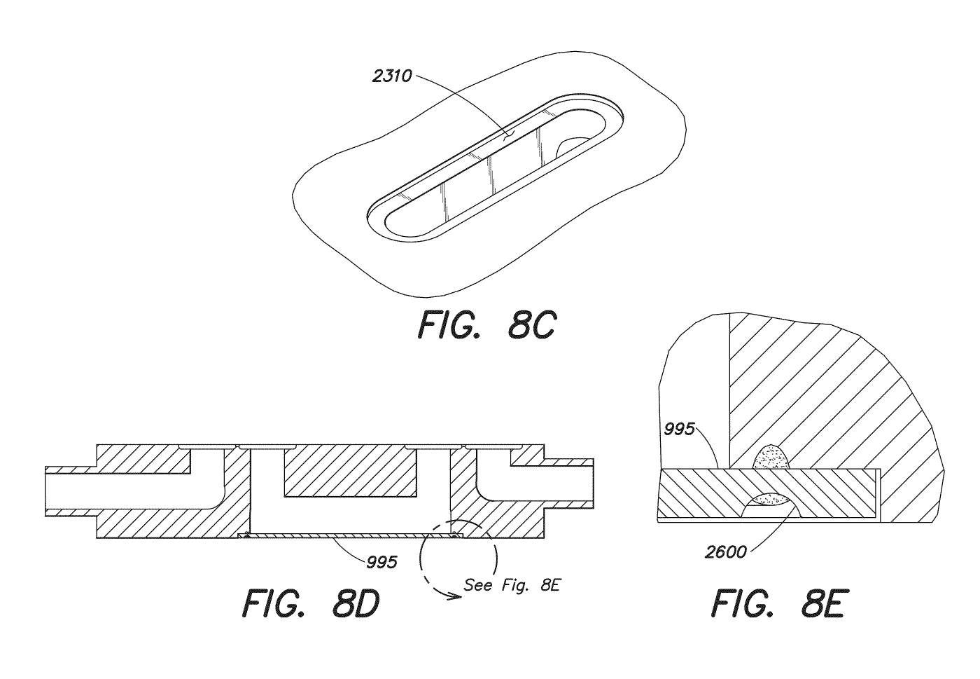

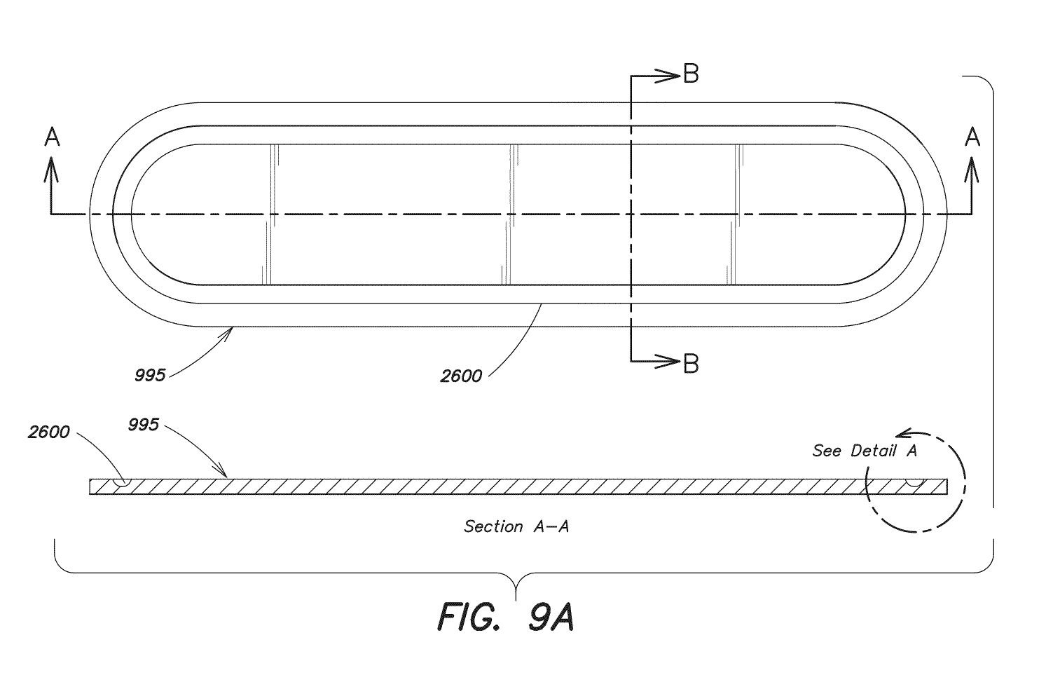

FIGS. 8A-E illustrate another embodiment of the present invention that uses individual caps to seal respective fluid pathways formed in the bottom surface of the body of the flow substrate. As in the prior embodiment of FIGS. 7A-E, this embodiment uses a weld cap 995 (depicted in FIGS. 9A-B) in which a weld formation in the form of a heat penetration groove 2600 is formed around a periphery of the cap 995. In contrast to the embodiment of FIGS. 7A-E, and as best seen in FIG. 8B, the weld formation of the embodiment of FIGS. 8A-E includes only a flat surface 2310 that is recessed in the bottom surface of the body of the flow substrate that surrounds a periphery of the fluid pathway. During manufacture, after placing a respective cap 995 over each of the fluid pathways to be sealed, each respective cap would be staked to the flat surface 2310 by, for example, by welding the cap to the flat surface at a number of discrete locations along the periphery of the fluid pathway, or by mechanical force, as noted above. As previously noted, the staking permits the substrate with its associated retained cap(s) to be manipulated as a single unit, and prevents movement of the cap during welding. Each respective cap may then be stake welded along the heat penetration groove 2600 to form a continuous weld seal. Because of the heat penetration groove formed around the periphery of the cap 995, the cap may be stake welded to the body of the flow substrate with less energy and less (or no) distortion to the body of the flow substrate than were it not present. FIG. 8E illustrates the manner in which the weld penetrates the body of the substrate.

FIGS. 9A-B illustrate a weld cap that is adapted to be stake welded to the body of a flow substrate. As shown in FIGS. 9A-B, the weld cap 995 includes a heat penetration groove 2600 that surrounds a periphery of the weld cap 995. The heat penetration groove 2600 may be formed by chemical etching, or by machining. The heat penetration groove 2600 reduces the thickness of the weld cap in the location of the groove by approximately 30% to 50%, and in the embodiment shown, by approximately 40%. In the embodiment shown, the thickness of the weld cap 995 is approximately 0.02 inches (0.5 mm) thick, the groove is approximately 0.020 to 0.025 inches wide (0.5 mm to 0.6 mm) at its widest point, and approximately 0.008 to 0.01 inches (0.2 mm to 0.25 mm) deep. Although shown as being semicircular in shape, it should be appreciated that other shapes may alternatively be used. By reducing the thickness of the weld cap, the heat penetration groove 2600 reduces the time and power necessary to form a continuous stake weld with the body of the flow substrate. The heat penetration groove 2600 in the cap also acts as a guide for the person or machine performing the welding. It should be appreciated that the weld cap 995 is similar in design to the integrated weld cap 195 of FIGS. 1A-J, in that the presence of the grooves 123, 2600 act as a guide during welding, and enable fluid pathways to be sealed using less power and time.

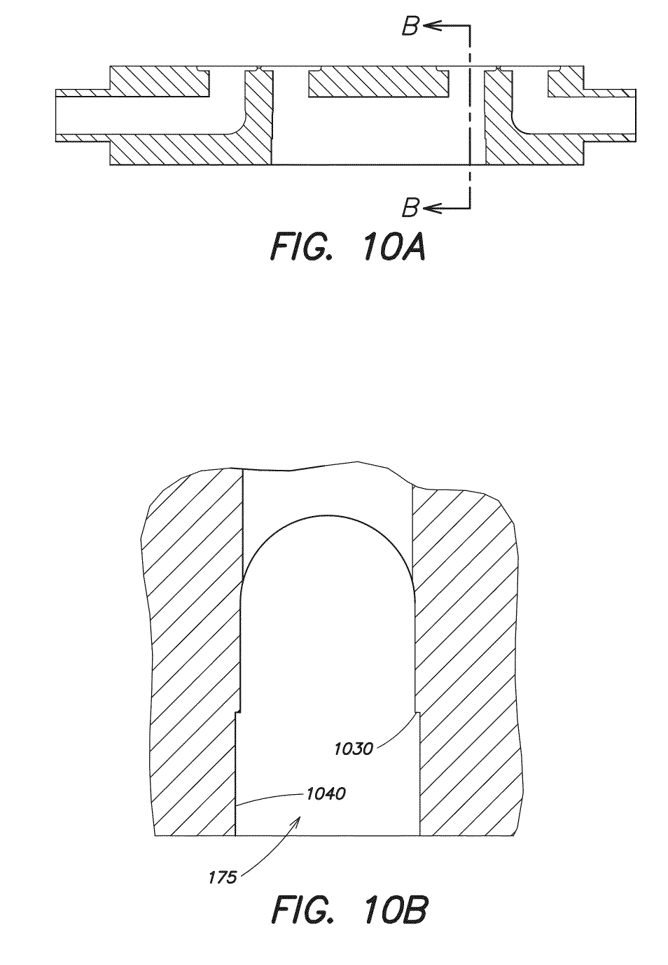

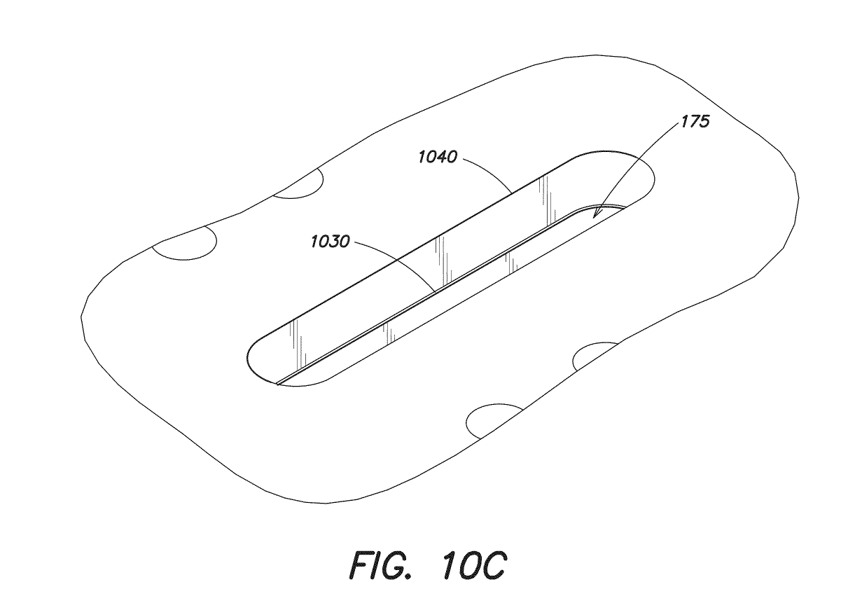

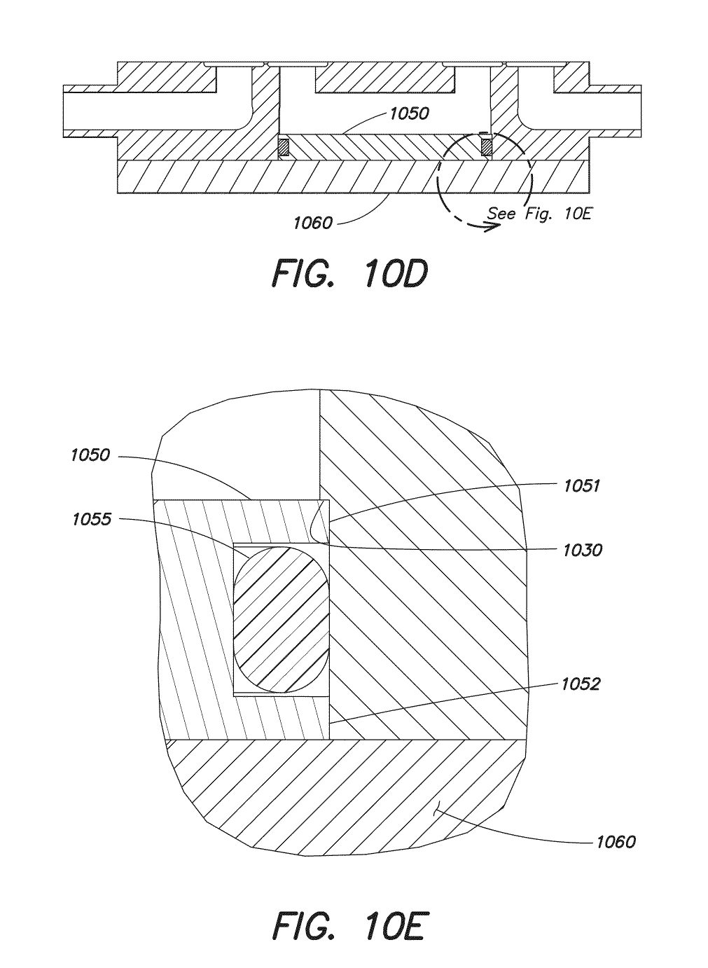

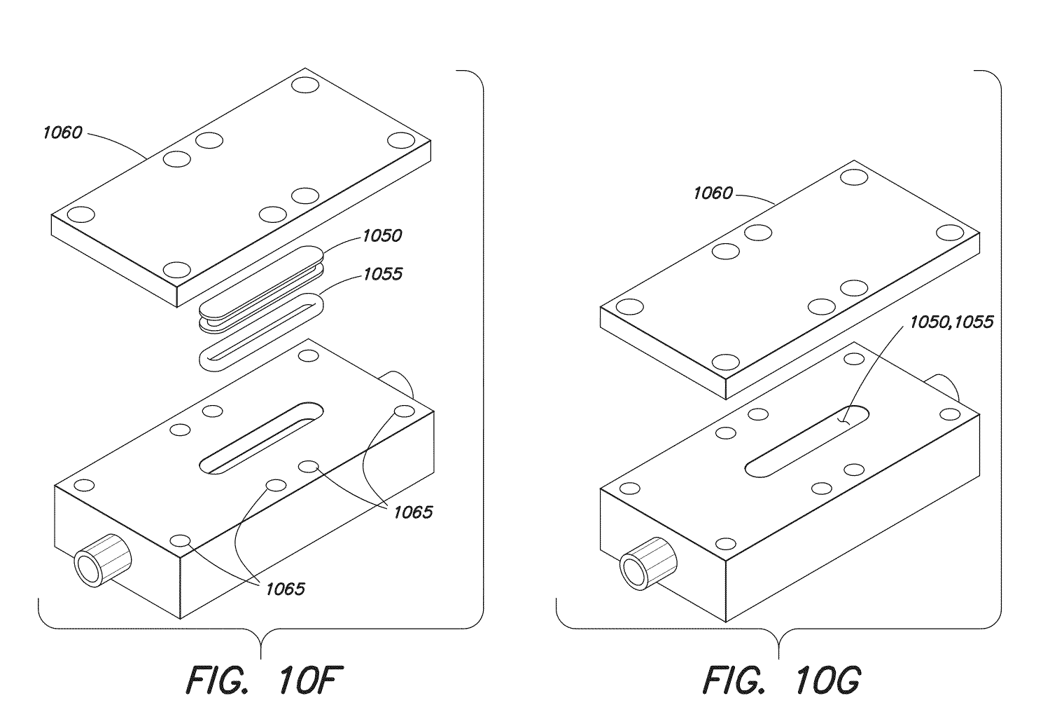

FIGS. 10A-G illustrate a flow substrate and associated cap in accordance with another embodiment of the present invention. In contrast to the embodiments of FIGS. 3-9 in which the caps are welded to the body of the flow substrate, the embodiment of FIGS. 10A-G utilizes elastomeric seals to seal the fluid pathway, as in the embodiment of FIGS. 2A-H. In the embodiment of FIGS. 10A-G, the flow substrate, the cap, or both the flow substrate and the cap may be formed from metal, or from non-metallic materials. For example, where it is desired to heat or cool the fluid in the flow substrate, metallic materials may be used, and where ionic contamination is a concern, non-metallic materials may be used.

As shown in FIG. 10B, the fluid pathway 175 includes a pocket region 1040 that is dimensioned to receive a cap 1050 and associated elastomeric seal 1055 (FIGS. 10D-F) and a positive stop ledge 1030 that is dimensioned to prevent further movement of the cap 1050 and associated elastomeric seal 1055 when compressed in the pocket region 1040 (FIG. 10E).

FIGS. 10D-G illustrate the manner in which a backup plate 1060 may be used to compress the cap 1050 and associated elastomeric seal 1055 within the pocket region of the fluid pathway 175. Threaded fasteners (not shown) that are received in internally threaded flow substrate mounting apertures 1065 compress the backup plate 1060 against the body of the substrate and force the cap 1050 and associated elastomeric seal into sealing engagement within the pocket region 1040. Depending on the application in which this embodiment is used, the flow substrate and the cap may be formed from metal or plastic. The backup plate 1060 may be formed from any suitable material, such as aluminum, where heating or cooling of the fluid in the fluid pathway is desired, or from plastic.

As shown most clearly in FIGS. 10E and F, the cap 1050 includes a pair of shoulders 1051 and 1052 that retain the elastomeric seal 1055 in position about the cap 1050 so that the cap 1050 and associated elastomeric seal 1055 may be inserted as a single unit. The pair of shoulders 1051, 1052 have the same dimensions so that the cap 1050 and its associated elastomeric seal 1055 may be inserted with shoulder 1051 engaging the positive stop ledge 1030, or with the shoulder 1052 engaging the positive stop ledge 1030.

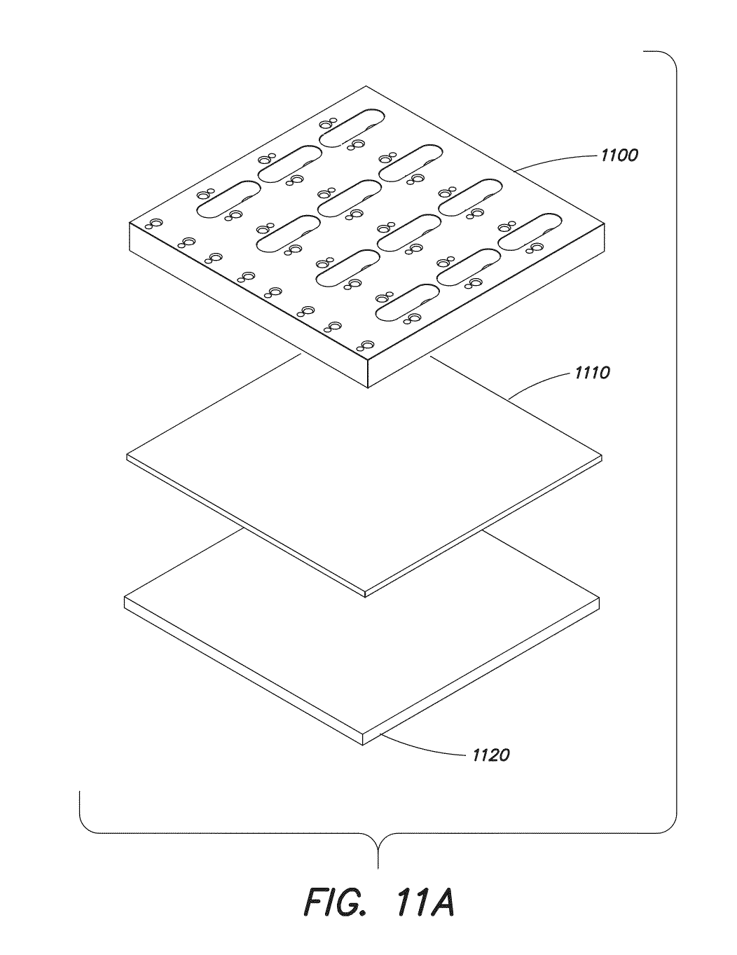

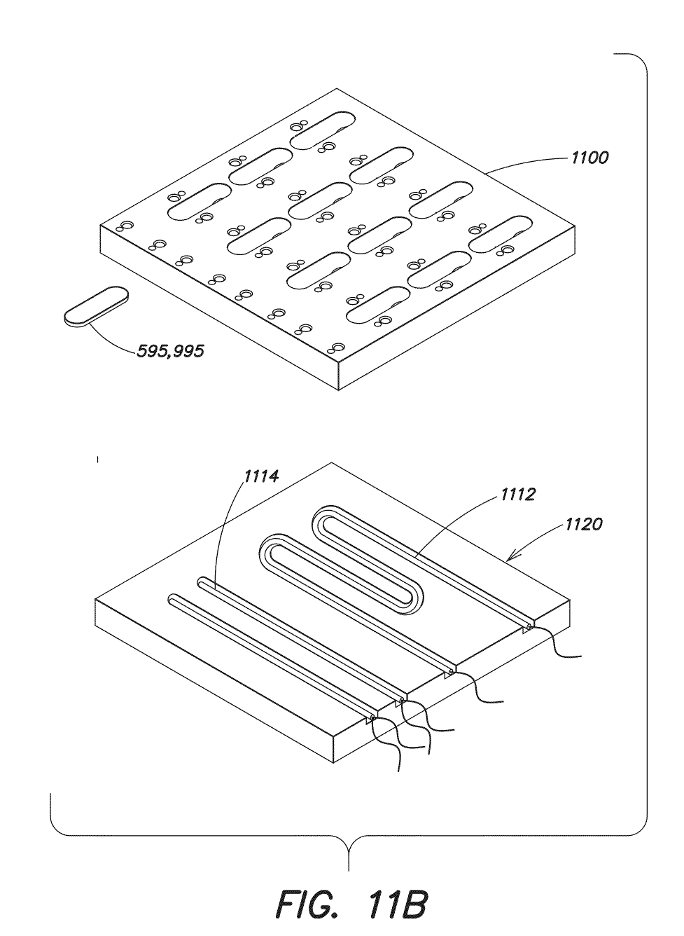

FIGS. 11A and 11B illustrate a number of further aspects of the present invention. As shown in FIGS. 11A and 11B, rather than using a number of flow substrates to form a gas stick or an entire gas panel, a single block of material 1100 may be used to form a gas stick or an entire gas panel. FIG. 11A also illustrates how a back-up plate 1120 may be used to reinforce the cap (or caps) for higher pressure applications. For example, when used with an integrated thin weld cap such as that shown in FIGS. 1A-J in which multiple pathway sealing weld locations are defined (e.g., by grooves 123 shown in FIG. 1I) in a thin sheet of material, a back-up plate 1120 may be desired to reinforce the weld cap, especially for high pressure applications. The back-up plate 1120 may be formed from a metallic material, such as aluminum, or a non-metallic material such as plastic. As also shown in FIG. 11A, a sheet heater 1110 may be located between the flow substrate (with associated cap or caps) and the back-up plate 1120. The combination of a thin integrated cap with sheet heater and back-up plate securely seals the fluid pathways for use at higher pressures, while allowing heat to be readily transmitted to the fluids flowing therein. As shown in FIG. 11B, rather than using an integrated weld cap, multiple individual weld caps, such as weld caps 595 and 995 (FIGS. 5 and 9) may be used. FIG. 11B further shows that rather than using a sheet heater 1110, a serpentine heater 1112 may be used that is embedded in a serpentine shaped groove in the back-up plate 1120, or alternatively still, a number of conventional cartridge-type heaters 1114 may be used.

It should be appreciated that the back-up plate shown in FIG. 11A may not only be used with the thin weld cap used in the embodiment of FIGS. 1A-J, but may also be used with the embodiment of FIGS. 10A-E to compress each of the o-ring seals used to seal each fluid pathway. Moreover, where the body of the flow substrate is formed from a non-metallic material, the back-up plate 1120 could be formed from a metallic material to provide additional support for any fluid component mounting. For example, fluid handling components disposed on the top surface of the flow substrate could then be down mounted to the body of the flow substrate via threaded fasteners that extend through holes formed in the body of the substrate and are received in threaded apertures of the back-up plate 1120.

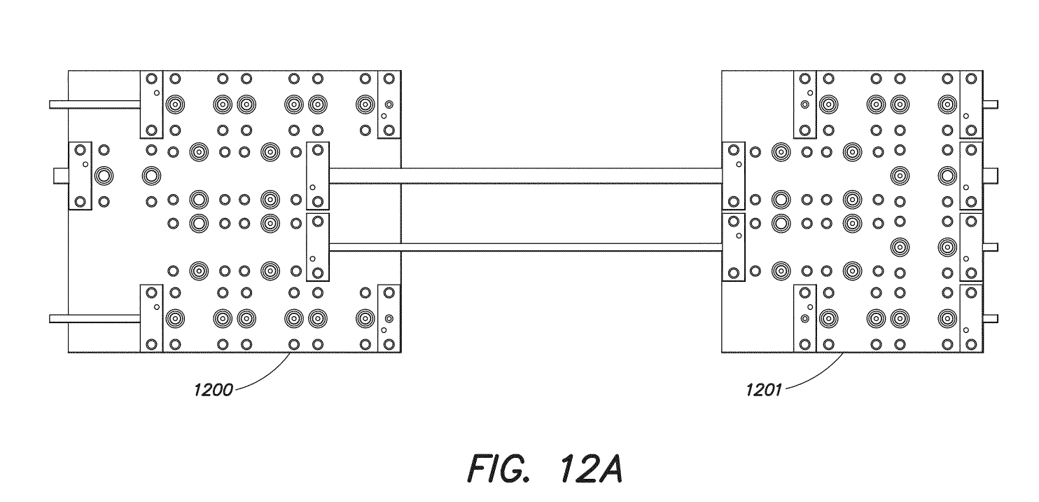

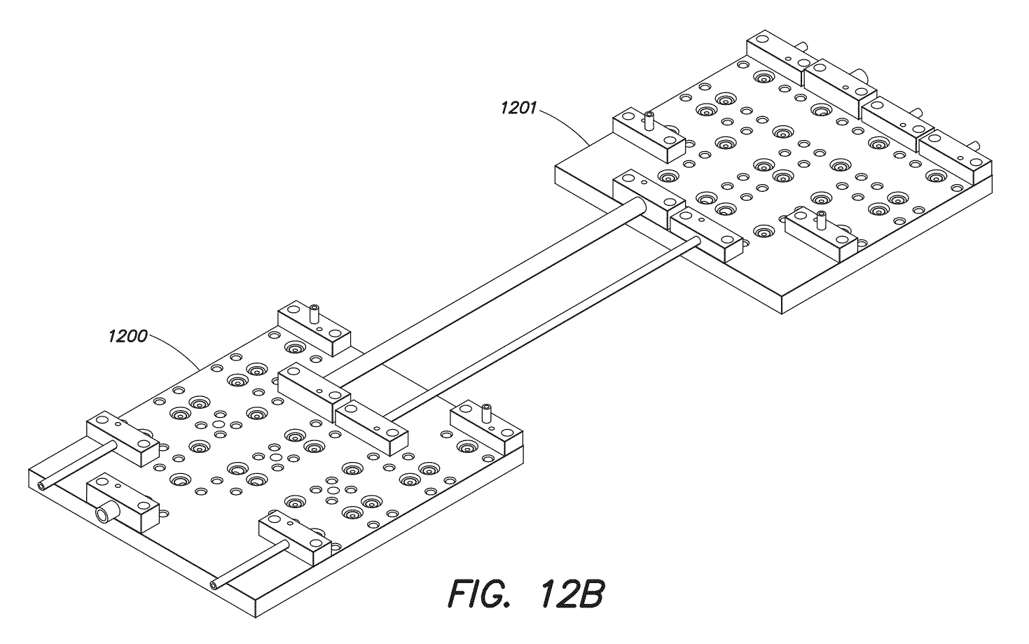

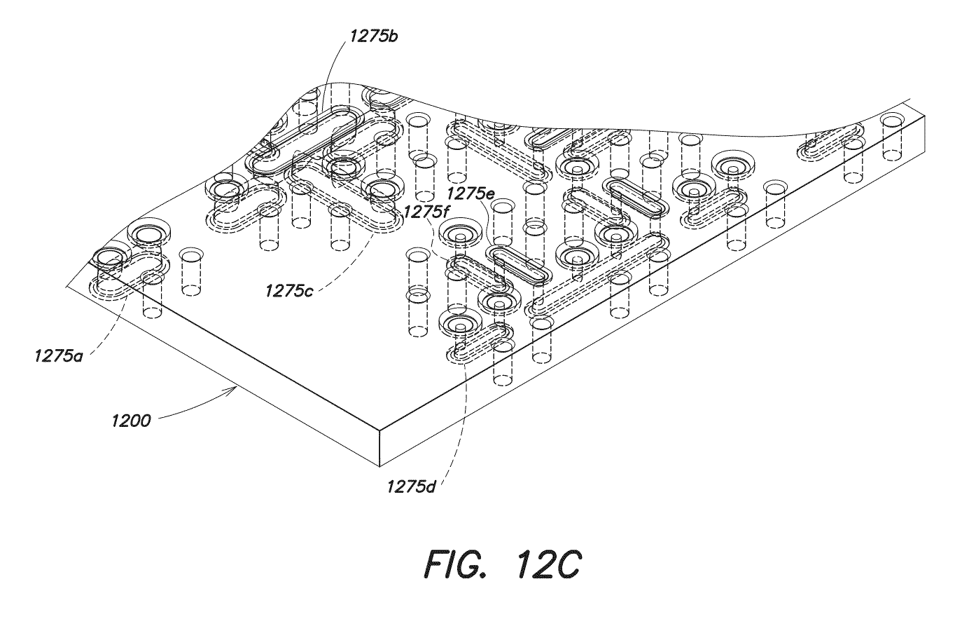

FIGS. 12A-C illustrate a gas panel for use with liquids, gases, or combinations of liquids and gases that exemplifies several additional aspects of the present invention. For example, as shown in FIG. 12A, an entire gas panel may be formed using only two flow substrates 1200, 1201, each of which incorporate several gas sticks (individual gas sticks in a given substrate would convey fluids from left to right in FIG. 12A). Further, as shown in FIGS. 12A-C, the substrates 1200, 1201 of this embodiment are adapted for use with fluid handling components having symmetric port placement, such as W-seal™ device, rather than those having asymmetric port placement. Moreover, as can be seen most clearly in FIG. 12C, the substrate 1200 may include fluid pathways having different flow capacities, fluid pathways oriented in different directions, and/or fluid pathways formed in opposing surfaces of the body of the substrate. For example, as shown in FIG. 12C, the substrate 1200 may include larger diameter fluid pathways 1275a, 1275b, 1275c formed in a bottom surface (pathway 1275a) or a top surface (fluid pathway 1275b) of the substrate 1200 to convey fluid in a first direction, or in a second direction (fluid pathway 1275c). Such larger diameter fluid pathways may be used to convey a purge gas or fluid, such as argon. The flow substrate may also include smaller diameter fluid pathways 1275d, 1275e, 1275f formed in a top surface or a bottom surface (fluid pathway 1275d) of the substrate 1200 to convey a fluid in the first direction, as well as smaller diameter fluid pathways formed in a top surface (fluid pathway 1275e) or a bottom surface (fluid pathway 1275f) to convey a fluid in the second direction. The smaller diameter fluid pathways 1275d, 1275e, and 1275f may be used to convey solvents or other liquids or gases. Although the embodiment illustrated in FIGS. 12A-C is adapted for use with a metal weld cap that is welded to the body of the substrate, it should be appreciated that this embodiment could alternatively be adapted for use with elastomeric seals. For example, for those fluid pathways formed in the bottom surface of the substrate, a backup plate (such as that described with respect to FIGS. 11A and 11B) could be used to compress the cap and elastomeric seals, while those fluid pathways formed in the top surface of the substrate could be formed so that fluid components mounted in registration with the top surface of the substrate are down mounted over the cap and seal and compress the associated cap and seal when fastened from above in sealing engagement with the conduit ports in the substrate.

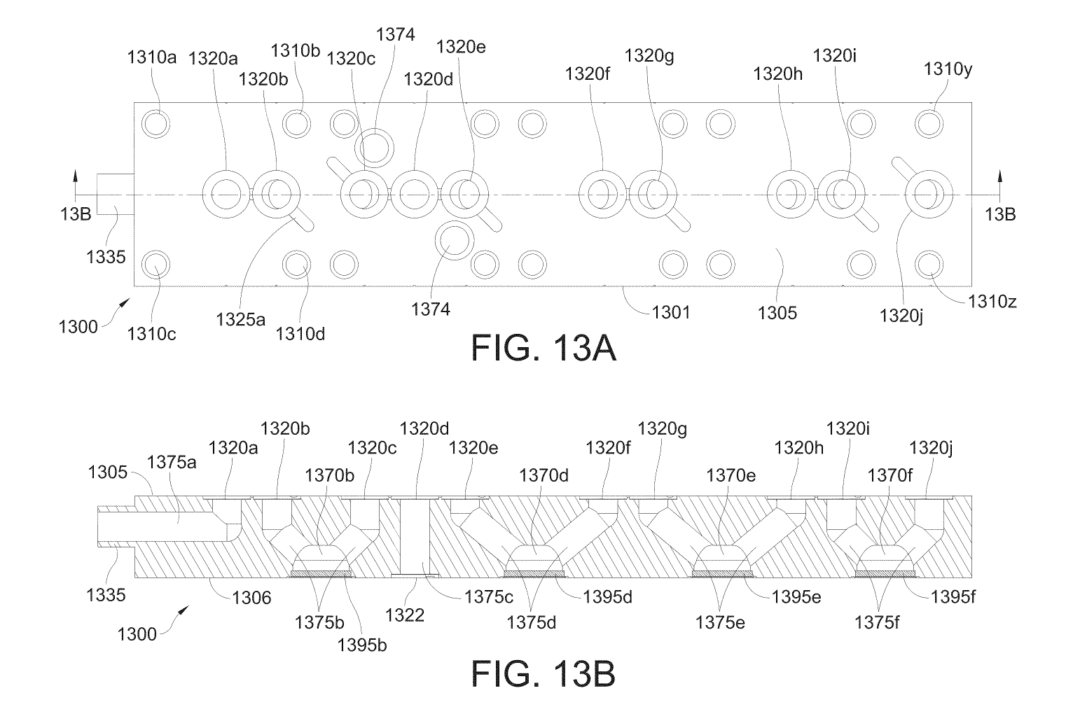

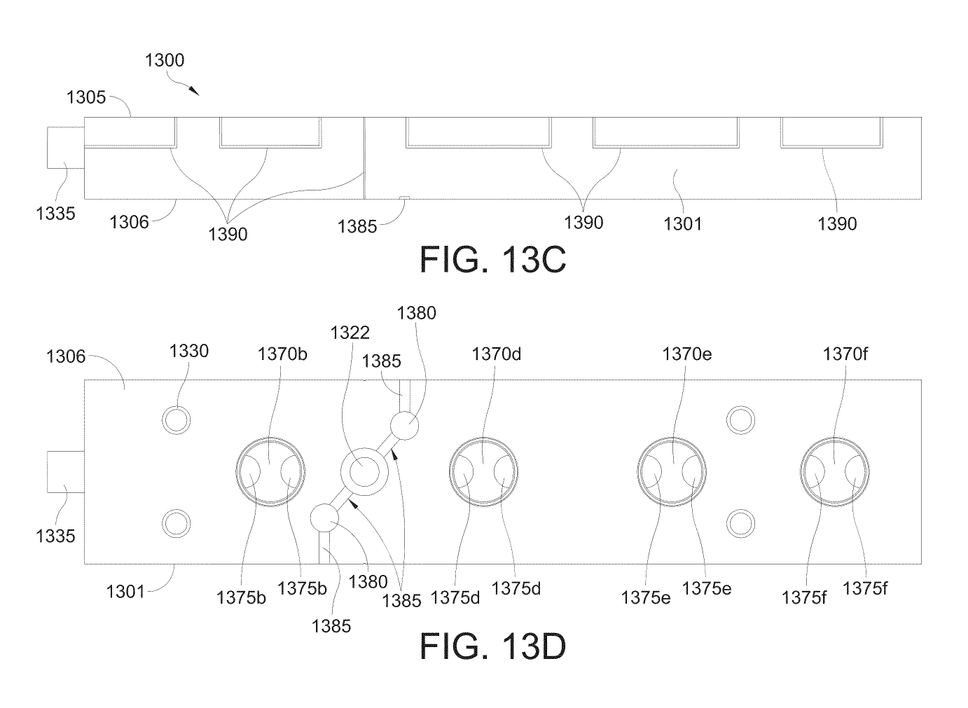

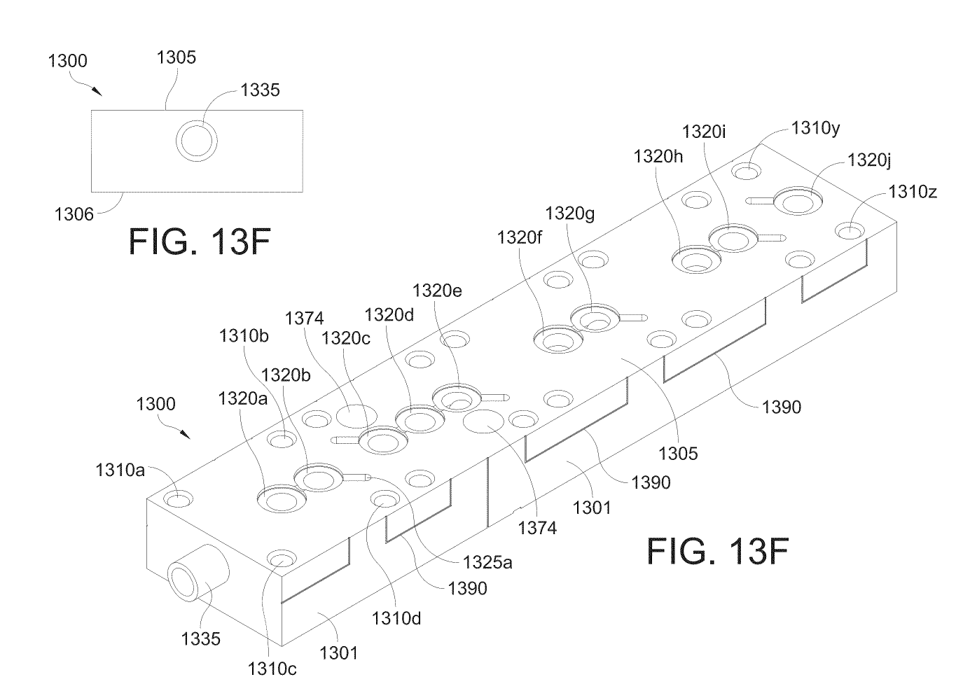

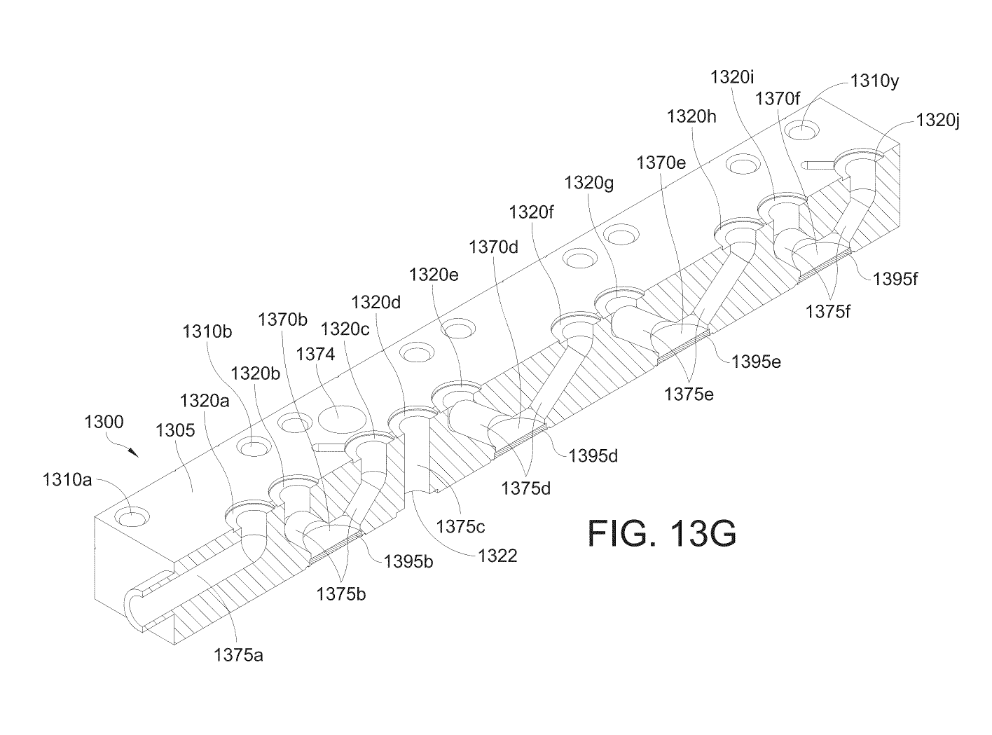

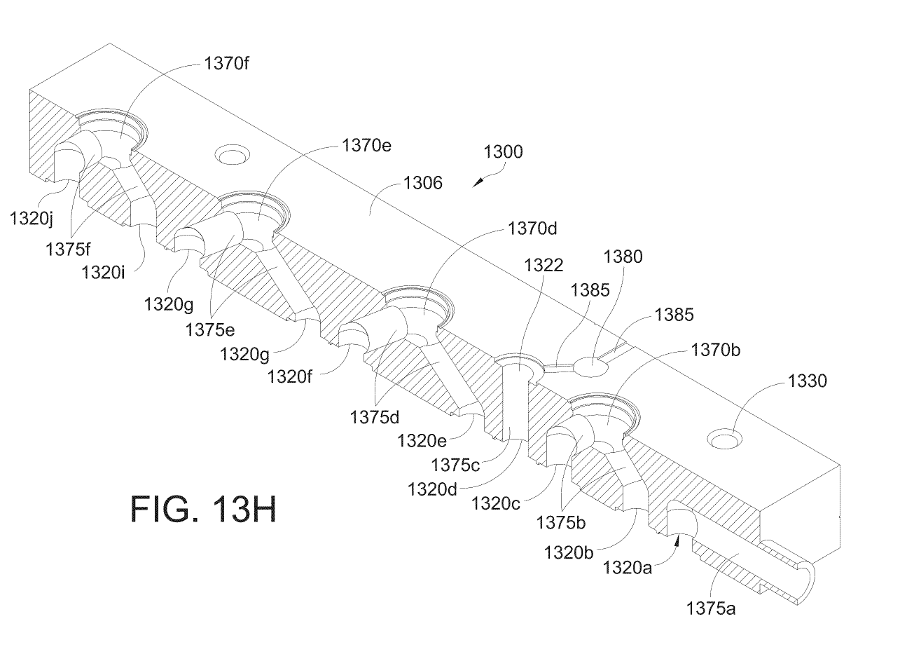

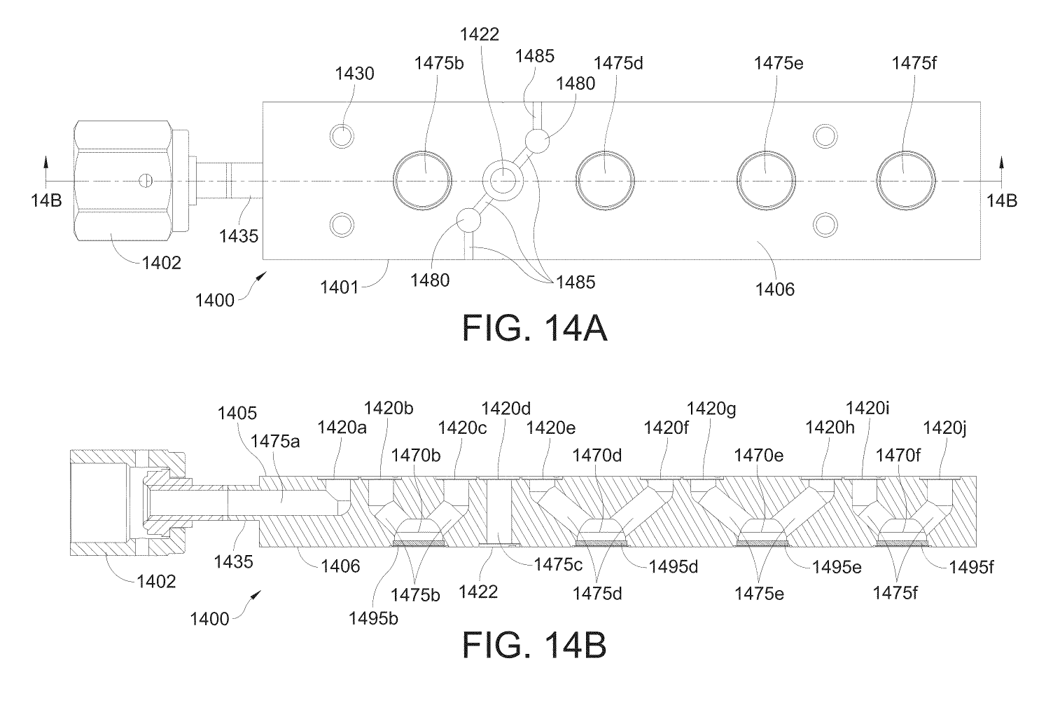

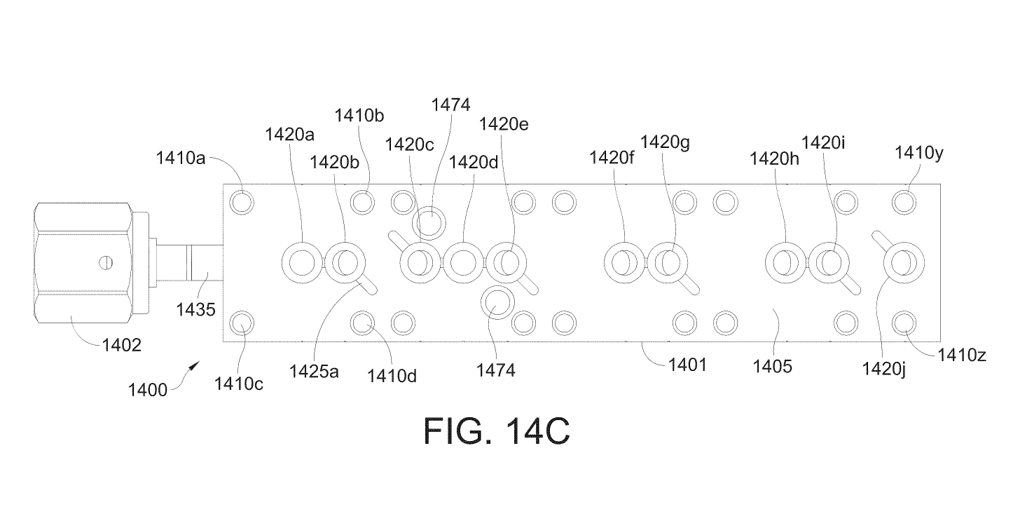

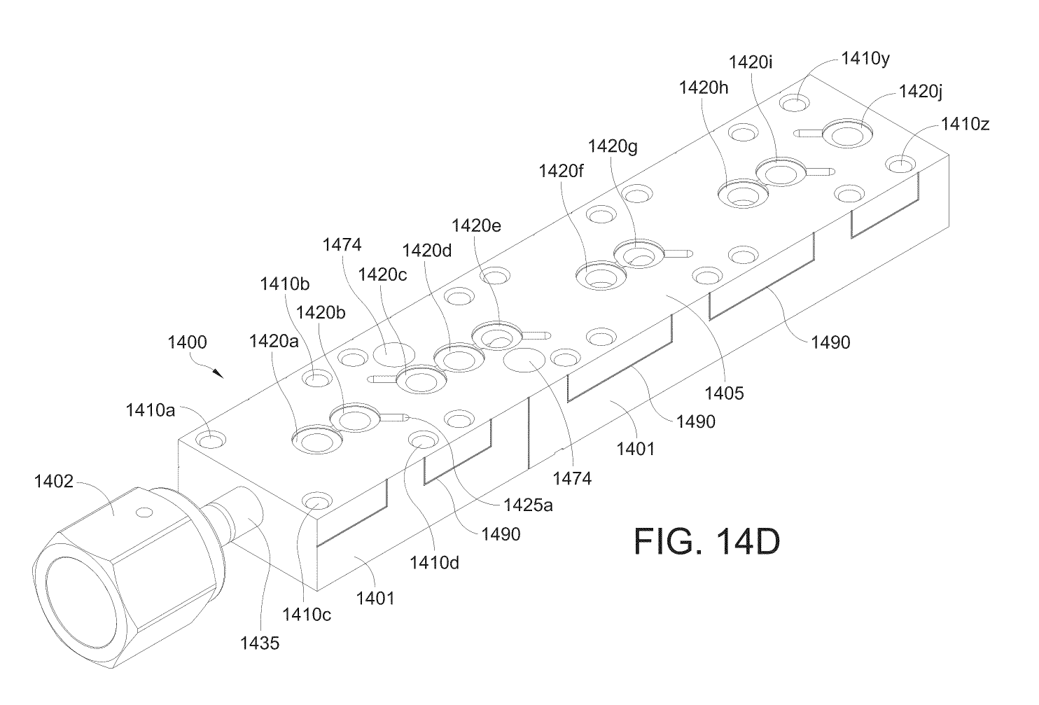

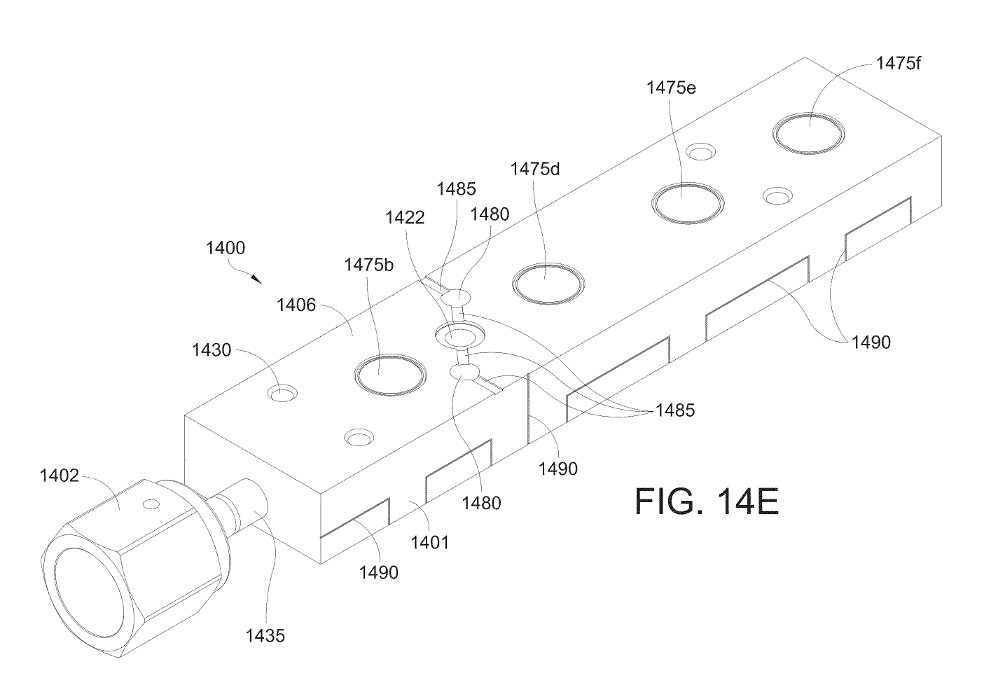

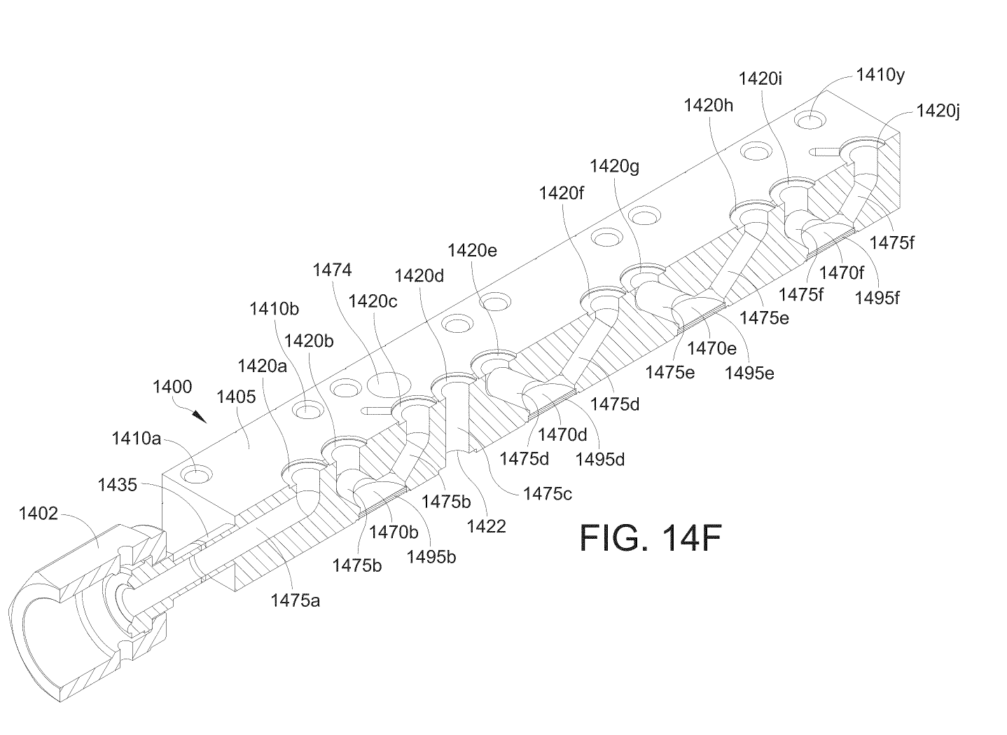

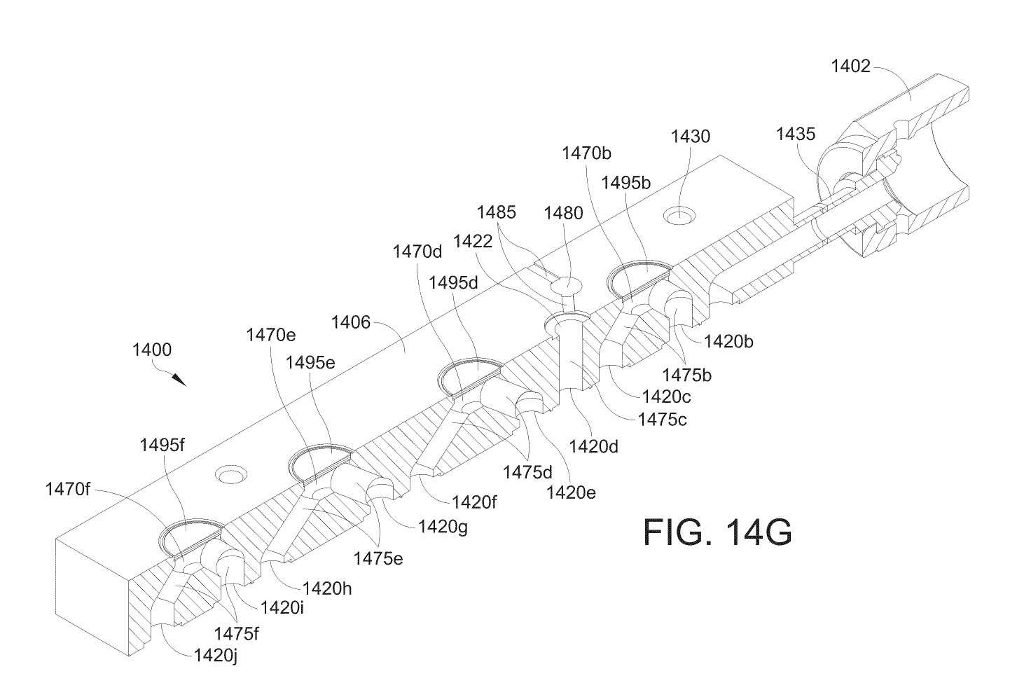

FIGS. 13 and 14 illustrate an alternative design of a flow substrate in accordance with the present invention. FIGS. 13A-13H are directed to a modular flow substrate 1300 that includes a component attachment surface 1305 to which a fluid handling component may be attached. As used herein, the terms “component attachment surface,” “first surface,” and “top surface” may be used interchangeably. In addition, the terms “connection attachment surface,” “second surface,” and “bottom surface,” may be used interchangeably. One or more component conduit ports 1320a-1320j, having similar functionality as that described with the previous embodiments, may be formed in the component attachment surface 1305 of the flow substrate 1300. Associated with each of the component conduit ports 1320 may be one or more internally threaded component mounting apertures 1310. For example, component mounting apertures 1310a, 1310b, 1310c, and 1310d may be associated with component conduit ports 1320a and 1320b. Each component mounting aperture 1310 may receive a threaded end of a fastener (not shown) that is used to sealingly mount the ports of a fluid handling component to the flow substrate 1300 in a manner similar to that described previously. Associated with each pair or grouping of component conduit ports may be a leak port, such as 1325a, that may detect any leakage between the conduit ports and the respective fluid handling component(s). In alternative embodiments, a leak port may be associated with each component conduit port.

As discussed previously, the flow substrate 1300 may include a number of fluid pathways 1375a, 1375b, 1375d, 1375e, and 1375f that are used to convey fluid in a longitudinal direction (i.e., from left to right in FIG. 13A) along the flow substrate 1300. The fluid pathways may include one or more segments that extend between a component conduit port formed in the top surface of the flow substrate 1300 and an aperture (discussed below) formed in the bottom surface 1306 of the flow substrate 1300. For example, in FIG. 13B, a first segment of a fluid pathway 1375b may extend between a first component conduit port 1320b and aperture 1370b, and a second segment of the fluid pathway may extend between a second component conduit port 1320c and aperture 1370b.

As noted above, the flow substrate 1300 may also include one or more apertures 1370 formed in the second or bottom surface 1306 of the flow substrate 1300. The apertures may be in fluid communication with one or more fluid pathways and one or more component conduit ports. For example, aperture 1370b may be in fluid communication with fluid pathway 1375b and component conduit ports 1320b and 1320c. In a similar manner, aperture 1370d may be in fluid communication with fluid pathway 1375d and component conduit ports 1320e and 1320f, aperture 1370e may be in fluid communication with fluid pathway 1375e and component conduit ports 1320g and 1320h, and aperture 1370f may be in fluid communication with fluid pathway 1375f and component conduit ports 1320i and 1320j. One or more of the apertures 1370 may have a circular cross-sectional area. As discussed above, a tube stub connection 1335 may be fluidly connected to a source or sink of process fluid.

In one or more embodiments, the flow substrate may include a plurality of component conduit ports that are associated with a plurality of apertures and a plurality of fluid pathways, where each fluid pathway of the plurality of fluid pathways includes a first segment extending between a respective aperture of the plurality of apertures and a first component conduit port of a respective pair of component conduit ports, and a second segment extending between the respective aperture and a second component conduit port of the respective pair of component conduit ports. In various embodiments, the fluid pathway may include one or more segments. For example, a fluid pathway may include one, two, three, or four segments. In some embodiments, one or more segments of a fluid pathway may share a common aperture. In a further embodiment, one or more segments of a fluid pathway may extend in a different direction than one or more other segments of the fluid pathway. For example, a first and second segment of a fluid pathway may extend longitudinally in a first direction, and a third segment may extend in a second direction that is different than the first direction, such as transverse to the first direction. Further, a third and fourth segment may extend in a second direction that is different than the first direction. Each segment of the fluid pathway may be associated with a respective component conduit port. In some embodiments, the flow substrate may further comprise at least one third component conduit port formed in the first surface of the substrate body and at least one fluid pathway extending parallel to the first surface and in fluid communication with the at least one third component conduit port.

The flow substrate 1300 may also include one or more fluid pathways oriented in a transverse direction. For example, the plurality of fluid pathways may form a first plurality of fluid pathways that extend in a first direction. The flow substrate may further comprise at least one fluid pathway that extends in a second direction transverse to the first direction. In certain instances, the at least one fluid pathway extending in the second direction may include at least one segment that has a different cross-sectional area than a cross-sectional area of at least one of the first segment and second segment of the first plurality of fluid pathways. In another embodiment, the plurality of component conduit ports may form a first plurality of component conduit ports and the plurality of fluid pathways may form a first plurality of fluid pathways that extend in a first direction. The flow substrate may further comprise at least one third component conduit port formed in at least one of the first surface and second surface of the substrate body and at least one fluid pathway that extends in a second direction that is transverse to the first direction and is in fluid communication with the at least one third component conduit port. In a further aspect, the at least one fluid pathway extending in the second direction includes at least one segment having a different cross-sectional area than a cross-sectional area of at least one of the first segment and second segment of the first plurality of fluid pathways. As will be appreciated by one of ordinary skill in the art, the at least one fluid pathway extending in a second direction may include one or more segments and may be associated with one or more component conduit ports and a respective aperture.

According to one or more aspects, and as discussed further below, the flow substrate may further comprise a third component conduit port that extends from the first surface of the substrate body and through the substrate body to the second surface of the substrate body. The third component conduit port may be configured to receive a fluid handling component that fluidly couples the third component conduit port with a first component conduit port of a respective first pair of component conduit ports and a second component conduit port of a respective second pair of component conduit ports.

The fluid handling components may have two ports, to mate with conduit ports, such as those illustrated by 1320a and 1320b, or in the alternative, may have three ports to mate with conduit ports, such as those illustrated by 1320c-1320e. This alternative arrangement may be useful for use with a three-way valve. For example, an inert gas or purge may be fluidly connected to a manifold port 1322 and provided through fluid pathway 1375c to the fluid handling component associated with one or more conduit ports, such as 1320c-e. The manifold port 1322 may be constructed in a similar manner as the component conduit ports 1320 discussed above. Associated with the manifold port 1322 may be one or more leak test channels 1385 that function to detect any leakage between the manifold port 1332 and a manifold (not shown) fluidly connected thereto. A plurality of through holes extend from the component attachment surface 1305 of the substrate 1300, into the body 1301 of the substrate and through to the opposing surface of the substrate body 1301, each to receive a fastener that mounts a manifold to the substrate body 1301 from below. As shown, each of the through holes can include a counter-bore 1374 formed in the component attachment surface 1305 of the substrate that is dimensioned to receive the head of a threaded fastener (not shown) and recess the head of the fastener below the component attachment surface 1305 of the substrate. The threaded end of each fastener can extend through a respective aperture 1380 and mate with threaded holes formed in a mating surface of the manifold to pull the manifold into sealing engagement with the manifold port 1322. The counter-bores 1374 thus permit a fluid handling component to be mounted to the component attachment surface 1305 of the substrate without interference from the head of the fasteners. Although the flow substrates illustrated in FIGS. 13 and 14 are illustrated as being designed to accommodate fluid handling components having three ports, it should be appreciated that other flow substrates in accordance with embodiments of the present invention may accommodate fluid handling components having only two ports, such as the substrate depicted in FIGS. 1A-1J. Other arrangements of fluid handling components are also within the scope of this disclosure.

In accordance with one or more embodiments, the fluid pathways may be circular in cross-section. For example, FIG. 13B illustrates a cross-sectional view, and FIGS. 13G and 13H illustrate cut-away elevational views of the flow substrate 1300, where the component conduit ports 1320, the apertures 1370, and the fluid pathways 1375 may each be machined out of a solid piece of material, such as stainless steel. As illustrated by the figures, the component conduit ports 1320 may each be formed by machining from the component attachment surface 1305 into the body 1301 of the flow substrate 1300. Fluid pathway 1375a may be formed by machining from a side surface of the body of the flow substrate 1300, and apertures 1370 may be formed by machining from a bottom surface 1306 of the flow substrate 1300.

Fluid pathways 1375b, 1375d, 1375e, and 1375f may each be formed by first machining vertically (i.e., perpendicular to the bottom surface of the substrate) from the bottom surface 1306 of the body 1301 of the flow substrate 1300 (to form the apertures 1370). As can be seen in the figures, one or more segments of the fluid pathway 1375 that extend from the aperture 1370 to a component conduit port 1320 may each be formed by machining further into the body 1301 at an angle through the aperture. For example, fluid pathway 1375b may be formed by first drilling into the bottom surface 1306 of the substrate 1300 at a point in between corresponding conduit ports 1320b and 1320c. In some instances, the first drilling point may be equidistant from corresponding conduit ports 1320b and 1320c. In other aspects, the first drilling point may be formed asymmetrically between the corresponding conduit ports. The initial cut extends in a vertical direction to a predetermined point in the body 1301 of the substrate 1300. This serves to form the aperture 1370.

One or more angled cuts may then be made further into the body 1301 of the substrate using the cavity of the aperture 1370 as the starting point and the corresponding conduit port 1320 as the ending point. For example, in FIG. 13B, two angled cuts are made through the bottom of the substrate to form first and second segments of each respective fluid pathway 1375b, 1375d, 1375e, and 1375f. The one or more angled cuts serve to form the segments of the fluid pathway. For example, using a center line perpendicular to the top surface 1305 and bottom surface 1306 of the substrate axis as a 90° reference, the fluid pathways 1375b and 1375f each have 45° angled first and second segments and fluid pathways 1375d and 1375e each have 40° angled first and second segments. The angled segments of the fluid pathway may be of any angle, depending on the positioning of the initial cut and the positioning of the corresponding conduit ports. For example, in some embodiments, the first segment and second segment may extend at an angle between 1° and 89° relative to the second or bottom surface 1306 of the substrate. In at least one embodiment, the first segment and second segment may extend at an angle between 35° and 50° relative to the second or bottom surface 1306. According to some embodiments, the first segment may extend at a different angle than the second segment. According to another aspect, a first segment and a second segment of a first fluid pathway may extend at a different angle than a first segment and a second segment of a second fluid pathway. In certain instances, corresponding conduit ports that are spaced father apart from each other may require one or more segments with a smaller angle. According to further aspects, a first segment may have a different cross-sectional area than a second segment, and a first and second segment of a first fluid pathway may have a cross-sectional area that is different than a first and second segment of a second fluid pathway.

In one or more embodiments, the angular segments of the fluid pathways may be formed by machining into the body of the substrate 1301 through the opening created by the conduit port 1320, i.e., through the top of the substrate 1305. In some embodiments, the apertures 1370 and fluid pathways 1375 may be formed first, before the machining of the corresponding conduit ports 1320.

The component conduit ports 1320, apertures 1370, and fluid pathways 1375 may each be formed by using any one of a number of different machining processes, including turning, boring, milling, and drilling techniques. For example, in some embodiments, a drill press may be used. The circular flow path created by the drill bit may be subjected to further processing, such as polishing. In addition, one or more surfaces may be treated to enhance corrosion resistance. As discussed above, the dimensions of the fluid pathways 1375 may be particularly well suited for very high flow rates, and may be scaled down for lower flow applications. It should be appreciated that although the cross-section for the flow paths and apertures is illustrated in the figures as being circular, other shapes are also within the scope of this disclosure.

The flow substrate 1300 may include a plurality of associated caps 1395b, 1395d, 1395e, and 1395f, with each cap being associated with a respective aperture 1370b, 1370d, 1370e, and 1370f. The caps may be similar in structure to the caps shown in FIGS. 5 and 9, and may be provided and configured as previously discussed. As shown in the figures, the caps may be round in shape, to accommodate a circular opening created by machining into the bottom of the substrate 1300, i.e., the aperture 1370. The caps may be formed by stamping or by machining a piece of stainless steel metal, for example, from a piece of bar stock on a lathe.

In accordance with certain aspects of this disclosure, the round caps may be used with a flow substrate forming multiple gas sticks, such as substrates comprising all or substantially all of a gas panel, such as the substrates illustrated in FIGS. 11 and 12. Other arrangements using the round caps are also within the scope of this disclosure.

As previously discussed with respect to FIGS. 3, 4, 6, 7, 8, and 10, the plurality of associated caps associated with each aperture may be recessed within the body of the substrate and then welded into place. For example, each of the apertures may be surrounded by a weld formation. The weld formation may be any of the formations discussed above, such as the swaged lip formation depicted in FIGS. 4A-4G or the stake welded formation depicted in FIGS. 7A-7E.

In other embodiments, the plurality of apertures formed within the substrate body 1300 may be sealed by a common or integrated cap, such as described above with respect to FIGS. 1 and 2. For example, the integrated cap may be welded to the bottom surface of the flow substrate around each of the apertures, or may be compressed against the bottom surface when used in combination with an elastomeric seal. In one or more embodiments, the cap may include one or more grooves to facilitate attachment to the substrate body. In some embodiments, the grooves may surround one or more apertures. As previously discussed, the grooves may be formed by chemical etching. The grooves may define the weld formation in a surface of the cap. The grooves may facilitate welding, since the thinness of the grooves may allow for easier attachment to the substrate body, since heat can transfer more readily through the thinner material. Further, the grooves may serve as a guide during the welding process. According to some embodiments, one or more component ports may extend, through vertical and/or angular flow paths, to a central pathway located in the bottom surface of the substrate. The integrated cap may be used to seal off one or more of these individual flow paths.

FIG. 13C illustrates a fluid flow diagram that may be included on a side surface of the flow substrate illustrated in FIG. 13B to visually identify the manner in which fluid can flow in the substrate. As shown, one or more markings 1390 may be visible on one or more edges or sides of the substrate. The markings 1390 may correspond to one or more fluid flow paths formed in the body of the substrate 1301, and may serve to assist service personnel in determining the route of one or more fluids through the body of the substrate.

FIGS. 14A-G illustrate a modular flow substrate 1400 that is functionally similar to the substrate shown in FIGS. 13A-H. As shown, the flow substrate 1400 may include a substrate body 1401 formed from a solid block of suitable material, as discussed previously. The flow substrate 1400 may include a fluid delivery inlet/outlet 1402 that may be configured to route fluid in a longitudinal direction between one or more flow substrates. In various embodiments, the one or more flow substrates may be oriented vertically or horizontally.

The use of the plurality of apertures, fluid pathways, and circular or round caps featured in FIGS. 13 and 14 may offer several advantages. For example, the circular cuts used to form these features may require less time and be less complicated to manufacture than the oblong slots illustrated in the flow substrates of FIGS. 1-10. Further, welding of a circular cap may be easier to perform than welding of an oval or elliptical shaped cap. For example, a circular cap may be easier to guide and maneuver during a welding or other attachment process. In addition, a wider range of thicknesses for the cap may be used, and the cap may be easily machined from bar stock on a lathe. Further, one or more weld formations, such as grooves, may be more easily formed on the surface of a circular cap.

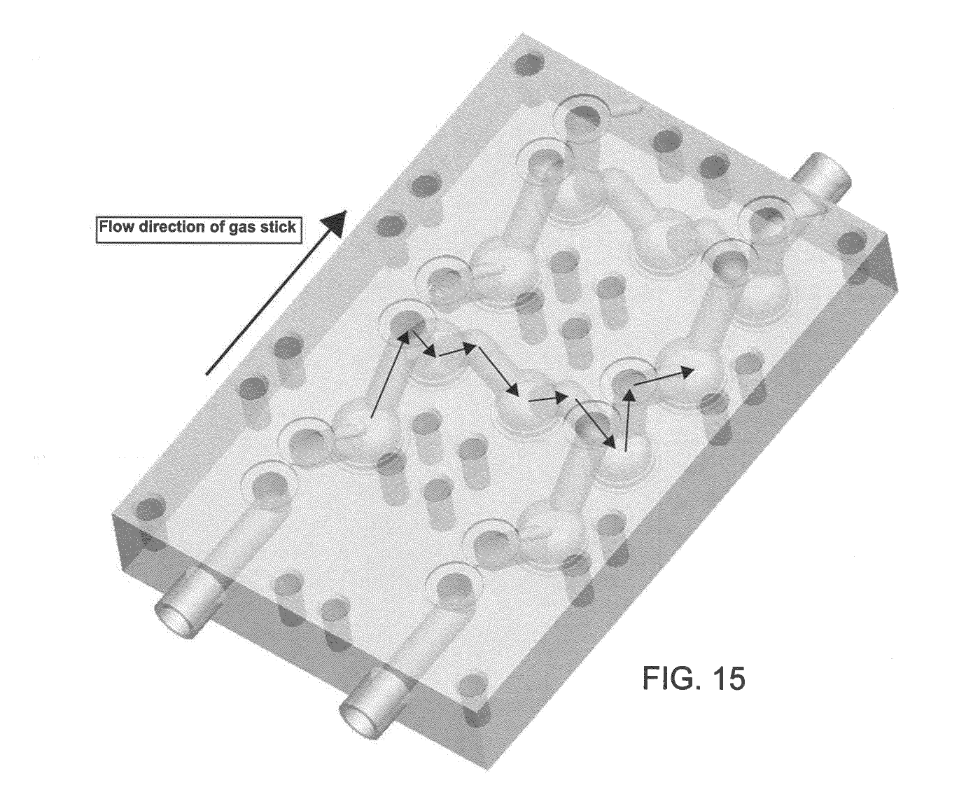

FIG. 15 illustrates an alternative design of a flow substrate in accordance with the present invention, and includes some of the same features as FIGS. 13 and 14. As shown, the flow substrate is wider than the flow substrates 1300 and 1400 featured in FIGS. 13 and 14 in order to accommodate a first and a second plurality of fluid pathways that each extend in a first direction along a first and second axis. The first and second plurality of fluid pathways may each be associated with one or more component conduit ports. In one or more embodiments, the first direction may represent the flow direction of one or more fluids passing through the fluid pathways, and the first and second axis may be substantially parallel to each other. The flow substrate may further include at least one fluid pathway that extends between the first and second plurality of fluid pathways in a second direction that is transverse to the first direction. The fluid pathway extending in the second direction may share a common aperture with the each of the first and second plurality of fluid pathways. The flow substrate may further include at least one aperture associated with the fluid pathway extending in the second direction. The at least one aperture may be positioned between the first and second plurality of fluid pathways. As shown, fluid may flow in a first direction along the first (upper) plurality of fluid pathways, and then flow in a second direction through fluid pathways positioned transverse to the first direction and extending in between the first and second plurality of fluid pathways. The fluid may switch directions again and flow in the first direction along the second (lower) plurality of fluid pathways. As will be appreciated by one of ordinary skill in the art, the flow substrate may include one or more fluid pathways that extend in a second direction and are configured as described above. Other variations are also within the scope of this disclosure. For example, although the flow substrate depicted in FIG. 15 is shown as including two sets of fluid pathways that extend generally parallel to one another in a first direction, it should be appreciated that additional fluid pathways may be provided, such that a single flow substrate may form all, or substantially all, of a gas panel.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the scope of the invention. Accordingly, the foregoing description and drawings are by way of example only.

What is claimed is:

1. A flow substrate comprising:
a substrate body formed from a solid block of a first material, the substrate body having a first surface and a second surface opposing the first surface;
a plurality of component conduit ports defined in the first surface of the substrate body;
a plurality of apertures defined in the second surface of the substrate body;
a plurality of fluid pathways, each fluid pathway of the plurality of fluid pathways including a first segment extending between a respective aperture of the plurality of apertures and a first component conduit port of a respective pair of component conduit ports and a second segment extending between the respective aperture and a second component conduit port of the respective pair of component conduit ports; and
at least one cap formed from a second material, the at least one cap having a first surface that is constructed to seal at least one aperture of the plurality of apertures, and a second surface opposing the first surface of the at least one cap;
wherein at least one of the substrate body and the at least one cap includes a weld formation formed in at least one of the second surface of the substrate body and the second surface of the at least one cap, the weld formation being constructed to surround the at least one aperture and facilitate welding of the at least one cap to the substrate body along the weld formation.

2. The flow substrate of claim 1, wherein the first segment and the second segment each extend at an angle relative to the second surface.

3. The flow substrate of claim 2, wherein the first segment and the second segment each extend at an angle between 35° and 50° relative to the second surface.

4. The flow substrate of claim 2, wherein the first segment extends at a different angle than the second segment.

5. The flow substrate of claim 2, wherein a first segment and a second segment of a first fluid pathway extends at a different angle than a first segment and a second segment of a second fluid pathway.

6. The flow substrate of claim 1, wherein the first segment has a different cross-sectional area than the second segment.

7. The flow substrate of claim 1, wherein the respective aperture of the plurality of apertures is formed equidistant between the first component conduit port and the second component conduit port of the respective pair of component conduit ports.

8. The flow substrate of claim 1, wherein the respective aperture of the plurality of apertures is formed asymmetrically between the first component conduit port and the second component conduit port of the respective pair of component conduit ports.

9. The flow substrate of claim 1, further comprising at least one third component conduit port formed in the first surface of the substrate body and at least one fluid pathway extending parallel to the first surface and in fluid communication with the at least one third component conduit port.

10. The flow substrate of claim 1, wherein the plurality of fluid pathways extend in a first direction, and the flow substrate further comprises at least one fluid pathway extending in a second direction that is transverse to the first direction.

11. The flow substrate of claim 10, wherein the at least one fluid pathway extending in the second direction includes at least one segment having a different cross-sectional area than a cross-sectional area of at least one of the first segment and the second segment.

12. The flow substrate of claim 10, wherein the plurality of fluid pathways that extend in the first direction includes a first plurality of fluid pathways extending in the first direction along a first axis and a second plurality of fluid pathways extending in the first direction along a second axis, the first axis being substantially parallel with the second axis, and the at least one fluid pathway extends in the second direction between the first plurality of fluid pathways and the second plurality of fluid pathways.

13. The flow substrate of claim 12, further comprising at least one aperture associated with the at least one fluid pathway and positioned between the first plurality of fluid pathways and the second plurality of fluid pathways.

14. The flow substrate of claim 1, wherein the plurality of component conduit ports are a first plurality of component conduit ports, the plurality of fluid pathways are a first plurality of fluid pathways that extend in a first direction, and the flow substrate further comprises at least one third component conduit port formed in at least one of the first surface and the second surface of the substrate body and at least one fluid pathway extending in a second direction that is transverse to the first direction and in fluid communication with the at least one third component conduit port.

15. The flow substrate of claim 14, wherein the at least one fluid pathway extending in the second direction includes at least one segment having a different cross-sectional area than a cross-sectional area of at least one of the first segment and the second segment.

16. The flow substrate of claim 1, wherein at least one aperture of the plurality of apertures has a circular cross-sectional area.

17. The flow substrate of claim 1, wherein the first component conduit port and the second component conduit port of the respective pair of component conduit ports is formed by machining from the first surface into the substrate body, each aperture of the respective plurality of apertures is formed by machining from the second surface into the substrate body, and each fluid pathway of the plurality of fluid pathways is formed by machining from the aperture to at least one of the first component conduit port and the second component conduit port.

18. The flow substrate of claim 1, wherein the at least one cap is constructed to seal at least two of the plurality of apertures.

19. The flow substrate of claim 1, wherein the flow substrate forms substantially all of a fluid delivery panel.

20. The flow substrate of claim 1, further comprising a third component conduit port extending from the first surface of the substrate body and through the substrate body to the second surface of the substrate body, the third component conduit port being configured to receive a fluid handling component that fluidly couples the third component conduit port with a first component conduit port of a respective first pair of component conduit ports and a second component conduit port of a respective second pair of component conduit ports.
